(19) United States
(12) Patent Application Publication
(10) Pub. No.: US 2015/0199872 A1
(43) Pub. Date: Jul. 16, 2015

(54) SYSTEM AND METHODS FOR OPERATING GAMING ENVIRONMENTS

(71) Applicant: Konami Gaming, Inc., Las Vegas, NV (US)

(72) Inventors: Jeffrey D. George, Las Vegas, NV (US); Wil Schrader, Las Vegas, NV (US); Darrel Riekhof, Las Vegas, NV (US)

(21) Appl. No.: 14/670,119

(22) Filed: Mar. 26, 2015

Related U.S. Application Data
(63) Continuation-in-part of application No. 14/484,068, filed on Sep. 11, 2014.
(60) Provisional application No. 61/881,238, filed on Sep. 23, 2013.
(60) Provisional application No. 61/975,476, filed on Apr. 4, 2014.

(51) Int. Cl. G07F 17/32

(52) U.S. Cl. CPC G07F 17/3237

(57) ABSTRACT

A system for use in operating gaming tables within a gaming environment is described herein. The system includes a controller configured to receive an area image of an observation area including a gaming table from a video imaging device, detect a region of interest being displayed in the area image, and generate an object record including an object image associated with the region of interest. The object image includes an object being displayed within the region of interest. The controller identifies an object attribute associated with the object as a function of the object image, determines a table state associated with the gaming table as a function of the object attribute and generates and stores a table state record indicative of the table state. The controller generates and displays an enhanced image including the area image of the observation area and the determined table state on the display device.

### CROSS-REFERENCE TO RELATED APPLICATION

This application is a continuation-in-part of U.S. patent application Ser. No. 14/484,068, filed Sep. 11, 2014, which claims priority to U.S. Provisional Application No. 61/881,238, filed Sep. 23, 2013, and claims priority to U.S. Provisional Application No. 61/975,476, filed Apr. 4, 2014, the disclosures of which are hereby incorporated by reference in their entirety for all purposes.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### TECHNICAL FIELD

The subject matter disclosed herein relates generally to a system for use in operating gaming environments, and more particularly, to methods and systems for us in operating gaming tables within a casino gaming environment.

### BACKGROUND OF THE INVENTION

The growth and competition in the casino gaming market in recent years has resulted in an increase in the amount of patrons visiting the gaming establishments and the number of table games available for play. Accurate and timely information related to the gaming turnover and occupancy at these table games has become increasingly important in an effort to increase the operating efficiencies of the gaming establishments.

A least some known monitoring systems require casino employees to track the number of players occupying gaming tables and the wagers being made by the players and enter the information into a computer system. Because these systems require input from the casino employees, the information contained in the system may include errors related to table occupancy and wagering information. In addition, casino employees may be delayed in inputting the information into the system, which results in delayed table estimates.

Some known monitoring systems may utilize complex arrays of cameras and RFID wagering chips to automate the collection of some wagering information. However, these systems require a significant infrastructure, and the use of special chips, that increases the cost over known systems.

Accordingly, new features are necessary to increase the accuracy of known monitoring systems to increase an efficient in determining wagering characteristics of the gaming environments. The present invention is directed to satisfying these needs.

### SUMMARY OF THE INVENTION

In one aspect of the invention, a system for identifying an object being displayed in a video image is provided. The system includes an audio/video server that is adapted to receive data indicative of video images an observation area and transmit signals indicative of the live video images to an object recognition server. The data may include video images associated with a table game, an area of a casino floor, and/or an area adjacent to a gaming machine. The object recognition server is configured to detect objects being included within the video images and identity the detected objects. The object recognition server may be configured to identify gaming objects being included in the video image such as, for example, cards use in a card game, casino chips used in wagering games, credit markers, monetary instruments, cash, coins, and/or any suitable objects. Moreover, the object recognition server may also identify a value of the identified object, e.g. a denomination of a cash instrument or coin, a value of the card, a rank and/or suite of a card, and/or a value of the casino chip. In addition, the object recognition server may be configured to determine a facial recognition of a player playing a gaming machine. Moreover, the object recognition server may receive image data associated with a human face and identify facial expressions associated with the video image, determine an age, gender, and/or race, and/or determine an identify of the associated individual.

In one aspect of the present invention, a system for use in operating gaming tables within a gaming environment is provided. The system includes a database, a user computing device including a display device, and an object recognition controller. The controller is configured to receive an area image of an observation area within the gaming environment from a video imaging device and store the area image in the database. The observation area includes a gaming table. The controller detects at least one region of interest being displayed in the area image and generates an object record including an object image associated with the at least one region of interest. The object image includes an object being displayed within the at least one region of interest. The controller identifies an object attribute associated with the object as a function of the object image, determines a table state associated with the gaming table as a function of the object attribute, and generates and stores a table state record indicative of the table state. The controller generates and displays an enhanced image including the area image of the observation area and the determined table state on the display device.

In another aspect of the present invention, a method of operating gaming tables within a gaming environment is provided. The method includes the steps of receiving an area image of an observation area within the gaming environment from a video imaging device and storing the area image in a database. The observation area includes a gaming table. The method includes detecting, by a processor, at least one region of interest being displayed in the area image and generating, by the processor, an object record including an object image associated with the at least one region of interest. The object image includes an object being displayed within the at least one region of interest. The method includes identifying an object attribute associated with the object as a function of the object image, determining a table state associated with the gaming table as a function of the object attribute, and generating and storing a table state record indicative of the table state. The method also includes generating and displaying an enhanced image including the area image of the observation area and the determined table state on a display device.

In yet another embodiment, one or more non-transitory computer-readable storage media, having computer-executable instructions embodied thereon are provided. When executed by at least one processor, the computer-executable instructions cause the processor to receive an area image of an observation area within the gaming environment from a video imaging device and store the area image in a database. The observation area includes a gaming table. The processor detects at least one region of interest being displayed in the area image, and generates an object record including an object image associated with the at least one region of interest. The object image includes an object being displayed within the at least one region of interest. The processor identifies an object attribute associated with the object as a function of the object image, determines a table state associated with the gaming table as a function of the object attribute and generates and stores a table state record indicative of the table state. The processor also generates and displays an enhanced image including the area image of the observation area and the determined table state on a display device.

In one aspect of the present invention, a system for use in operating gaming tables within a gaming environment is provided. The system includes a user computing device including a display device, an imaging device for capturing and transmitting video images of an observation area within the gaming environment, and a system controller coupled to the user computing device and the imaging device. The system controller is configured to receive a live video image including a gaming table, display the live video image within a display area on the display device, and display an event area within the display area. The event area overlays a portion of the gaming table image. The system controller detects a triggering condition associated with the event area and responsively generates an event record. The triggering condition includes a change in an image characteristic within the event area. The event record is indicative of game play at the gaming table. The system controller determines a gaming metric associated with the gaming table as a function of the event record and displays a notification indicative of the gaming metric on the display device.

In another aspect of the present invention, a system for use in operating gaming tables within a gaming environment is provided. The system includes a user computing device including a display device, an imaging device for capturing and transmitting video images of an observation area including a gaming table, and a system controller coupled to the user computing device and the imaging device. The system controller is configured to receive a live video image including the gaming table and display the live video image within a display area on the display device. The live video image includes a plurality of image characteristics. The system controller displays an event area within the display area. The event area overlaying a portion of the image of the gaming table. The system controller detects a triggering condition associated with the event area and responsively generates an event record. The triggering condition is defined as a change in an image characteristic within the event area. The event record is indicative of game play at the gaming table. The system controller determines a gaming metric associated with the gaming table as a function of the event record, determines a condition of the game play to be less than a predefined condition if the determined gaming metric is different than a predefined gaming metric, and responsively selects a corrective action as a function of the determined condition. The system controller also displays a notification indicative of the condition of game play and the corrective action on the display device.

In yet another aspect of the present invention, a method of operating gaming tables within a gaming environment is provided. The method includes the steps of receiving a live video image from an imaging device and displaying the live video image within a display area on a display device. The live video image includes an image of a gaming table. The method includes displaying an event area within the display area, the event area overlaying at least a portion of the image of the gaming table, detecting a triggering condition associated with the event area, and responsively generating an event record. The triggering condition includes a change in an image characteristic within the event area. The event record is indicative of game play at the gaming table. The method includes determining a gaming metric associated with the gaming table as a function of the event record, determining a condition of game play to be less than a predefined condition if the gaming metric is different than a predefined gaming metric, responsively selecting a corrective action as a function of the determined condition, and displaying a notification indicative of the condition of game play and the selected corrective action on the display device.

In another aspect of the present invention, a method of monitoring a condition of a gaming environment including a plurality of observations areas is provided. The method includes displaying, on a display device, a live video image of at least one observation area within a display area. The live video image includes a plurality of image characteristics. At least one event selection area is displayed within the display area. The selection area overlays at least a portion of the observation area video image. The method includes detecting a triggering condition associated with the selection area, determining a monitoring event record associated with the triggering condition, and displaying a notification message indicative of the monitoring event record. The method also includes displaying a plurality of selection areas within the display area, assigning a triggering condition to each of the plurality of selection areas, wherein at least one selection area includes a triggering condition that is different from one other selection area, and assigning a monitoring event to each of the assigned triggering conditions, wherein at least one selection area includes a monitoring event that is different from at least one other selection area.

The method also includes monitoring at least one image characteristic associated with the selection area over a predefined period of time and determining a state of the selection area as a function of the monitored image characteristic. The method also includes determining a first state associated with the selection area, determining a second state associated with the selection area, and detecting the triggering condition if the second state is different from the first state. The method also includes determining a state change between the first state and the second state and detecting the triggering condition if the determined state change is different from a threshold state change. The method also includes detecting the image characteristic including a brightness level at a predefined period of time, and detecting the triggering condition if the detected brightness level is different from a baseline brightness level. The method may also include monitoring the brightness level associated with the selection area over a predefined period of time, determining an average brightness level as a function of the monitored brightness level, and determining the baseline brightness level as a function of the average brightness level.

In addition, the method includes determining an area characteristic associated with the observation area as a function of the determined monitoring event and displaying a notification indicative of the determined area characteristic. The method may also include determining a condition of the observation area as a function of the determined area characteristic and displaying a notification if the determined observation area condition is different from a predefined condition. The method also includes monitoring the area characteristic over a period of time including generating area characteristic data indicative of the area characteristic at predefined time period intervals, determining historic characteristic trend data as a function of the area characteristic data, and displaying a trace indicative of the determined historic characteristic trend data on the display device. The method may also include generating predictive area characteristic data as a function of the historic characteristic trend data, and displaying a predictive trace indicative of the predictive area characteristic data on the display device. The method may also include selecting an area modification action associated with the observation area, generating predictive area characteristic data as a function of the historic characteristic trend data and the selected area modification action, and displaying a predictive trace indicative of the area characteristic data on the display device.

In addition, the method includes determining a player tracking account associated with the selection area, determining a player tracking event associated with the monitoring event, generating a player tracking record indicative of the player tracking event, and updating the player tracking account as a function of the player tracking record.

In yet another aspect of the present invention, a system for monitoring a condition of a gaming environment that includes a plurality of observation areas is provided. The system includes a user computing device including a display device, an audio/video server, a player tracking server, an event recognition server, a yield management server, a database, and a controller that is connected to the user computing device, the audio/video server, the player tracking server, the event recognition server, the yield management server, and the database. The audio/video server is adapted to receive data indicative of live video images of at least one observation area of the plurality of observations areas and transmit signals indicative of the live video images to the event recognition server. The player tracking server is configured to receive data indicative of player tracking events, generate player tracking data as a function of the player tracking events and store the player tracking data in corresponding player tracking accounts associated with a plurality of players.

The event recognition server is configured to receive data indicative of live video images and generate data indicative of monitoring events associated with the at least one observation area. The yield management server is configured to receive information associated with the monitoring events and generate data indicative of a condition of the gaming environment as a function of the monitoring events. The database is adapted to receive, store, and transmit data indicative of the live video images, the player tracking accounts, the monitoring events, and the gaming environment conditions.

The controller is configured to display, on the display device, a live video image of at least one observation area within a display area including a plurality of image characteristics, display at least one selection area within the display area with the selection area overlaying at least a portion of the observation area video image, detect a triggering condition associated with the selection area, determine a monitoring event associated with the triggering condition, and display a notification message indicative of the monitoring event.

The controller is also configured to display a plurality of selection areas within the display area, assign a triggering condition to each of the plurality of selection areas, wherein at least one selection area includes a triggering condition that is different from one other selection area, and assign a monitoring event to each of the assigned triggering conditions, wherein at least one selection area includes a monitoring event that is different from at least one other selection area. The controller also monitors at least one image characteristic associated with the selection area over a predefined period of time and determines a state of the selection area as a function of the monitored image characteristic. The controller also determines a first state associated with the selection area, determines a second state associated with the selection area, and detects the triggering condition if the second state is different from the first state. The controller also determines a state change between the first state and the second state and detects the triggering condition if the determined state change is different from a threshold state change. The controller also detects an image characteristic including a brightness level, detects the brightness level associated with the selection area at a predefined period of time, and detects the triggering condition if the detected brightness level is different from a baseline brightness level. The controller also monitors the brightness level associated with the selection area over a predefined period of time, determines an average brightness level as a function of the monitored brightness level, and determines the baseline brightness level as a function of the average brightness level.

In addition, the controller may also determine an area characteristic associated with the observation area as a function of the determined monitoring event and display a notification indicative of the determined area characteristic. The controller may also determine a condition of the observation area as a function of the determined area characteristic and display a notification if the determined observation area condition is different from a predefined condition.

The controller may also monitor the area characteristic over a period of time including generating area characteristic data indicative of the area characteristic at predefined time period intervals, determine historic characteristic trend data as a function of the area characteristic data, and display a trace indicative of the determined historic characteristic trend data on the display device. The controller may also be configured to generate predictive area characteristic data as a function of the historic characteristic trend data and display a predictive trace indicative of the predictive area characteristic data on the display device. The controller may also select an area modification action associated with the observation area, generate predictive area characteristic data as a function of the historic characteristic trend data and the selected area modification action, and display a predictive trace indicative of the area characteristic data on the display device.

In addition, the controller may also be configured to determine a player tracking account associated with the selection area, determine a player tracking event associated with the monitoring event, generate a player tracking record indicative of the player tracking event, and update the player tracking account as a function of the player tracking record.

### BRIEF DESCRIPTION OF THE DRAWINGS

Other advantages of the invention will be readily appreciated as the same becomes better understood by reference to the following detailed description when considered in connection with the accompanying drawings wherein:

FIG. 1 is a schematic representation of an exemplary system for monitoring an operation of a gaming environment, according to an embodiment of the invention;

FIG. 2 is schematic view of an event recognition controller that may be used with the system shown in FIG. 1;

FIG. 3 is schematic view of a yield management controller that may be used with the system shown in FIG. 1;

FIG. 4 is a schematic representation of a player tracking system that may be used with the system shown in FIG. 1, according to an embodiment of the invention; and,

FIG. 5 is a schematic representation of a device that may be used with the player tracking system shown in FIG. 4.

FIG. 6 is a flowchart of a method that may be used with the system shown in FIG. 1 for operating a gaming environment, according to an embodiment of the present invention;

FIGS. 7-24 are exemplary graphical displays of operating screens that may be displayed by the system shown in FIG. 1, according to an embodiment of the present invention;

FIG. 25 is another schematic representation of the system shown in FIG. 1, according to an embodiment of the invention;

FIG. 26 is schematic view of an object recognition controller that may be used with the system shown in FIG. 25;

FIGS. 27-29 are flowcharts of methods that may be used with the system shown in FIGS. 1 and 25 for operating a gaming environment, according to an embodiment of the present invention; and

FIGS. 30-52 are exemplary graphical displays of operating screens that may be displayed by the system shown in FIG. 1, according to an embodiment of the present invention.

Corresponding reference characters indicate corresponding parts throughout the drawings.

### DETAILED DESCRIPTION OF THE PREFERRED EMBODIMENT

With reference to the drawings, and in operation, the present invention overcomes at least some of the disadvantages of known monitoring systems by providing a system for use in operating a casino gaming environment that includes a object recognition controller that is configured to receive a video image of a gaming area including a gaming table, recognizes objects such as, for example playing cards and/or monetary currency being used during game play on a gaming table, determines a value of the playing cards and/or currency and generates and displays an enhanced image of the gaming table including the values of the playing cards and/or currency being used during the game. In addition, the object recognition controller is configured to identify regions of interest in the video image that include one or more objects, extract and normalize images of the regions of interest, and recognize objects being displayed in regions by using a feature detection image operations and/or a template matching image operation. In one embodiment, the system controller matches the images of the objects with baseline object images using a using a feature detection image operations and/or a template matching image operation. The system may also generate confidence values based on the matching operations and selects matching baseline object images based on the confidence values. The system also generates object records indicative of the objects that include attributes associated with the matched baseline object image for use in displaying the object information on the enhanced gaming table image.

In addition, the system may be configured to detect objects being included within the video images and identity the detected objects. For example, the system may identify gaming objects being included in the video image such as, for example, cards use in a card game, casino chips used in wagering games, credit markers, monetary instruments, cash, coins, and/or any suitable objects. Moreover, the system may identify a value of the identified object, e.g. a denomination of a cash instrument or coin, a value of the card, a rank and/or suite of a card, and/or a value of the casino chip. In one embodiment, the system may be configured to determine a facial recognition of a player playing a gaming machine. For example, the system may receive image data associated with a human face and identify facial expressions associated with the video image, determine an age, gender, and/or race, and/or determine an identify of the associated individual.

By extracting and normalizing images of objects, using calculated confidence values using image feature detection and/or image template matching, and using the confidence values to determine matching baseline images and assigning object attributes, the system controller reduces the amount of computing resources that are required to recognize objects displayed in video images, and increases the speed at which an object may be recognized over known monitoring systems.

In addition, by providing a system that generates gaming metrics based on changes in the video characteristics of live video images of table game play, the manpower required to operate a gaming casino is reduced over known systems, and the accuracy of the generated gaming metrics is increased. Thus increasing the operating efficient of the gaming environment and reducing the overall operating costs.

In one embodiment, the system controller displays a live video image of a gaming table and overlays the image with a plurality of event areas for use in determining a plurality of gaming metrics associated with the game play at the gaming table. More specifically, the system controller detects a triggering condition associated with an event area including a change in the video area image characteristic within the event area and responsively generates and event record that is indicative of game play at the gaming table. The system controller determines a gaming metric associated with the gaming table as a function of the event record, determines a condition of game play as a function of the gaming metric, and responsively selects a corrective action as a function of the condition of game play.

In general the system includes a display device, a video imaging device, and a system controller that is connected to the display device and the video imaging device. The system controller is configured to monitor video images of an observation area within a gaming environment, detect a triggering condition associated with the observation area, generate a monitoring event record as a function of the triggering condition, and determine a condition of the observation area as a function of the generated monitoring event record. In addition, the system displays an event selection area over a portion of the video image, determines a state change associated with the event selection area over a period of time, and detects the triggering condition if the state change is different from a threshold state change. Moreover, the system determines an area characteristic and/or a gaming metric associated with the observation area as a function of the generated monitoring event record, and displays a notification to a user that is indicative of the determined area characteristic/gaming metric. In addition, the system may determine an historic characteristic trend as a function of the area characteristics/gaming metrics and display the historic trend to the user. Moreover, the system is configured to generate a predictive trend of area characteristics/gaming metrics associated with the observation area as a function of the historical trend. The system is also configured to select an area modification action associated with the observation area and generate the predictive trend as a function of the historic trend and the selected area modification action.

In general, the system is configured to monitor a condition of a monitored environment. In the illustrated embodiment, the monitored environment includes a gaming environment such as, for example, a casino environment. In another embodiment, the monitored environment may include any suitable environment that may be monitored using the system described herein. For example, in one embodiment, the system may be configured to monitor a table game positioned within a casino and to generate predictive trends of area characteristics and/or gaming metrics associated with play at the gaming table. For example, the system may receive live video images of the gaming table and a game being played on the gaming table, and display the images on a display device. The system may display, on the display device, a plurality of event selection areas on the display device, with each event selection area covering a portion of gaming table. For example, each selection area may extend over a seating position at the gaming table. The system may monitor a level of brightness associated with each selection area and detect a triggering condition if the level of brightness within a corresponding selection area increases over a threshold brightness level. The system may also determine a monitoring event associated with the triggering condition such as, for example, a player being seated within the seating position. The system may also determine a number of players playing at the table game based on the number of triggering conditions being detected within each event selection area and/or the number of monitoring events being associated with each selection area. In addition, the system may determine an area characteristic and/or a gaming metric such as, for example, a table occupancy level associated with the observation area as a function of the number of player being seated at the gaming table.

Moreover, the system may monitor the gaming table over a period of time including the area characteristic and/or the gaming metric, and determine historic characteristic trend data as a function of the change in area characteristics and/or gaming metrics over time. The system may also recommend area modification actions based on the historic trends such as, for example, opening another gaming table for play, adjusting a wager limit, closing the gaming table, and/or any action associated with the observation area. The system may generate a predictive characteristic trend as a function of the recommended action and display the trend to a user to illustrate a predicted change in the area characteristic as a function of the recommended action.

In addition, the system is configured to display a video image within a display area, determine a plurality of event zones, e.g., event selection areas and/or “Hot Spots”, within the display area, determine a normal state associated with each of the plurality of event zones, detect a state change from the normal state to a non-normal state, detect a triggering condition as a function of the detected state change, and record the event in the database for real time, dynamic learning or historical trending in response to detecting the triggering condition. Upon recording the event, a rules/dispatch engine may evaluate the event to provide a notification to a user upon detecting the triggering condition and/or creating an even record and/or an Event ID indicative of the occurrence of the triggering condition in a database.

Moreover, the system may use different algorithms to fine tune and optimize the detection of changes in the Hot Spots. The system may also be configured to simultaneously monitor and detect changes to multiple Hot Spots, record the data in the database for real-time event triggers, and generate a future analysis (Yield Management). In addition, the system may also include a dynamic learning aspect of the yield management to predict area characteristics and/or gaming metrics as a function of selected modification actions.

By providing a monitoring system that monitors selected areas of an observation area using video images, generates monitoring events based on the changes within the selected areas, and generates historic trends of area characteristics and/or gaming metrics associated with the observation area, the manpower required to monitor and observe activity within a gaming environment is significantly reduced. In addition, by generating predictive trends associated with various modification actions, the amount of information generated and displayed to a user is significantly increased, thus increasing the overall profitability of the gaming environment.

A selected embodiment of the invention will now be explained with reference to the drawings. It will be apparent to those skilled in the art from this disclosure that the following description of the embodiment of the invention is provided for illustration only and not for the purpose of limiting the invention as defined by the appended claims and their equivalents.

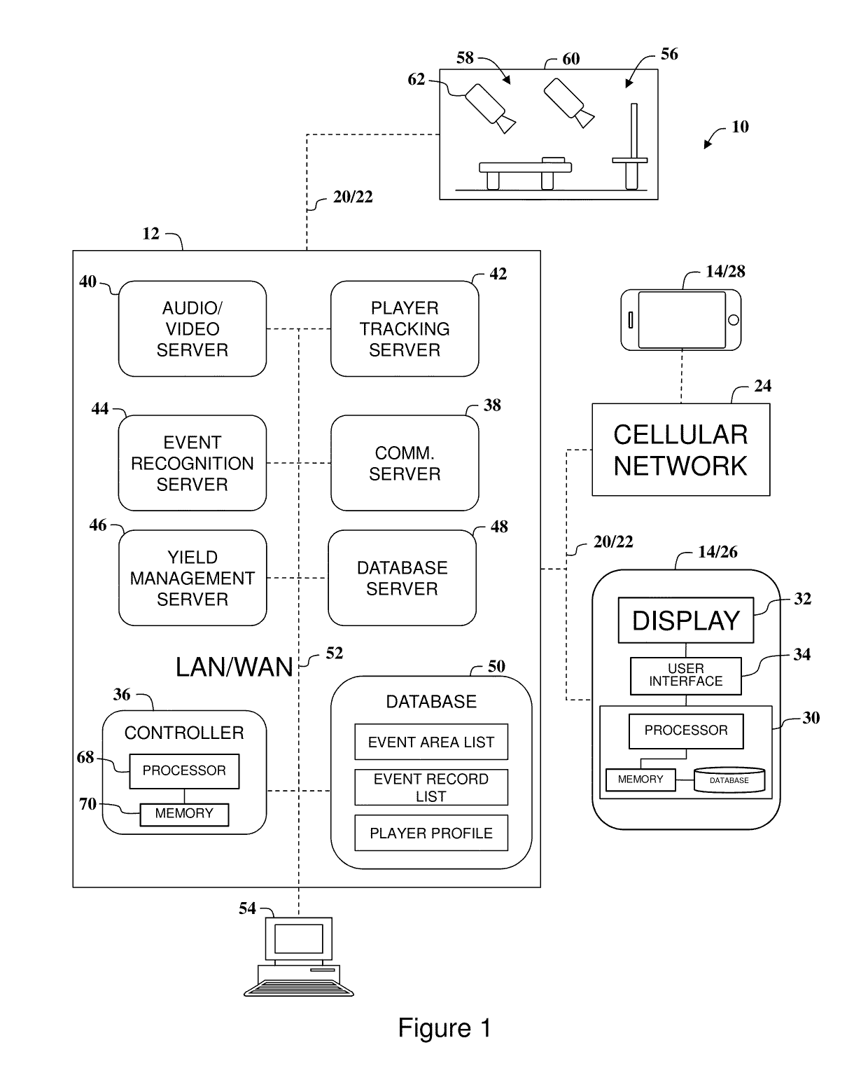

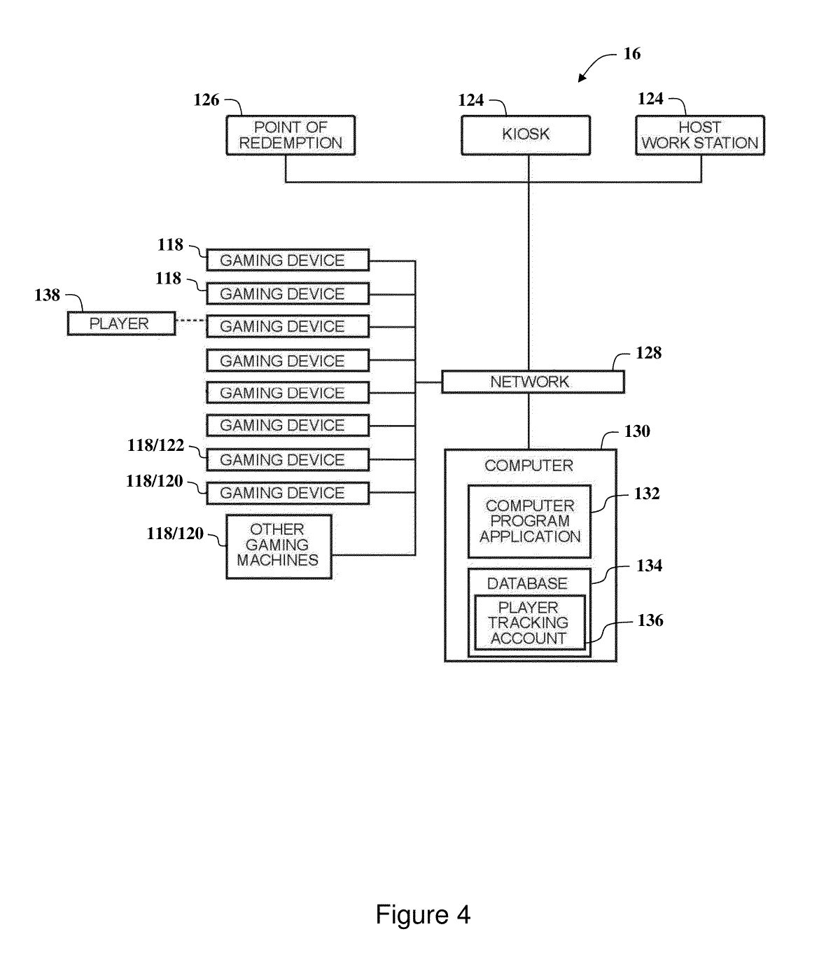

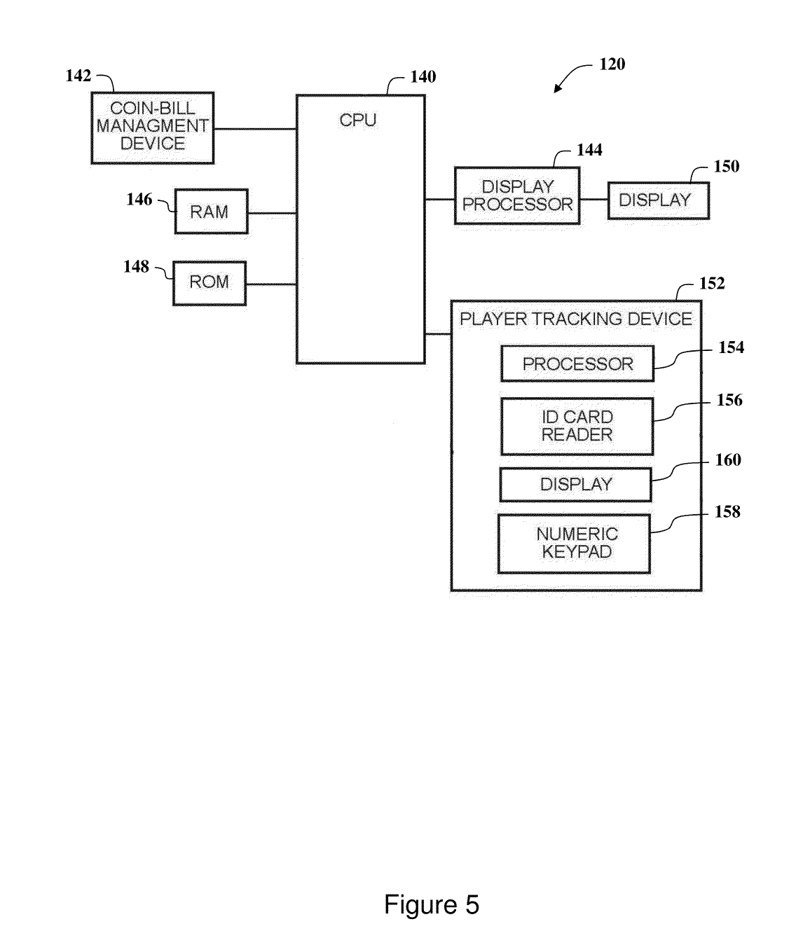

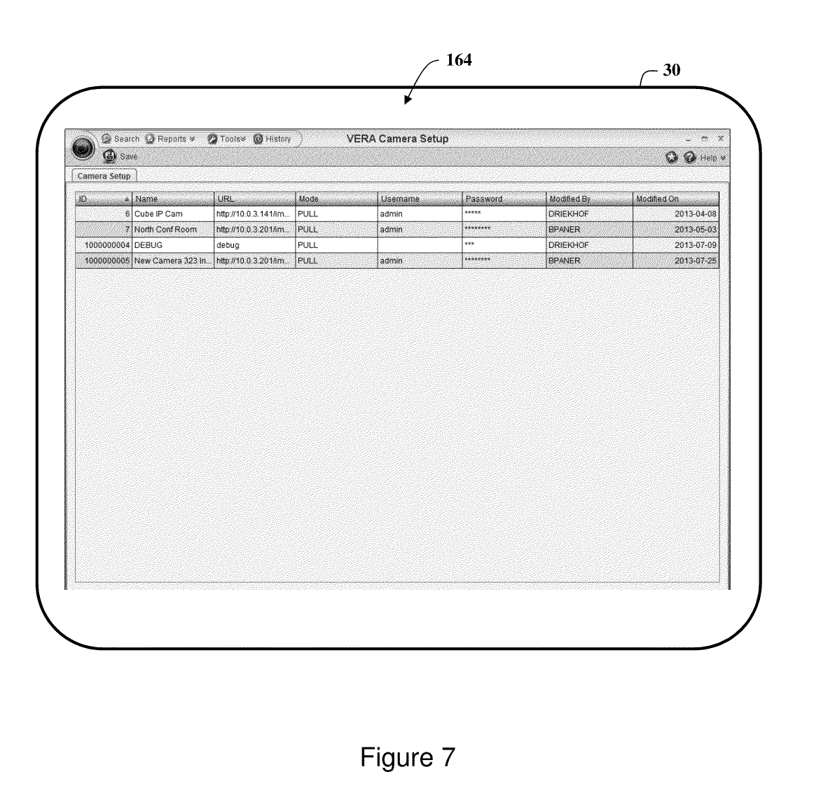

FIG. 1 is a schematic representation of an entertainment and monitoring system 10, according to an embodiment of the invention. In the illustrated embodiment, the system 10 includes a server system 12 that is coupled to one or more user computing devices 14, and a player tracking system 16 (shown in FIGS. 4 and 5) that is coupled to the server system 12. Each user computing device 14 is configured to transmit and receive data to and/or from the server system 12 to display graphical interfaces 18 (shown in FIGS. 7-24) to enable a user to monitor a condition of an environment with the user computing device 14. In the illustrated embodiment, the server system 12 is coupled to each user computing device 14 via a communications link 20 that enables each user computing device 14 to access server system 12 over a network 22 such as, for example, the Internet, a cellular telecommunications network 24, a wireless network and/or any suitable telecommunication network. For example, in one embodiment, the user computing device 14 includes a mobile computing device 26, e.g., a smartphone 28 that communicates with the server system 12 via the cellular telecommunications network 24 and/or the Internet. In another embodiment, the user computing device 14 may include a personal computer, laptop, cell phone, tablet computer, smartphone/tablet computer hybrid, personal data assistant, and/or any suitable computing device that enables a user to connect to the server system 12 and display the graphical interfaces 18.

In the illustrated embodiment, each user computing device 14 includes a controller 30 that is coupled to a display device 32 and a user input device 34. The controller 30 receives and transmits information to and from the server system 12 and displays the graphical interfaces 18 (shown in FIGS. 7-24) on the display device 32 to enable the user to interact with the server system 12 to monitor a condition of an environment in accordance with the embodiments described herein. The display device 32 includes, without limitation, a flat panel display, such as a cathode ray tube display (CRT), a liquid crystal display (LCD), a light-emitting diode display (LED), active-matrix organic light-emitting diode (AMOLED), a plasma display, and/or any suitable visual output device capable of displaying graphical data and/or text to a user. Moreover, the user input device 34 includes, without limitation, a keyboard, a keypad, a touch-sensitive screen, a scroll wheel, a pointing device, a barcode reader, a magnetic card reader, a radio frequency identification (RFID) card reader, an audio input device employing speech-recognition software, and/or any suitable device that enables a user to input data into the controller 30 and/or to retrieve data from the controller 30. Alternatively, a single component, such as a touch screen, a capacitive touch screen, and/or a touchless screen, may function as both the display device 32 and as the user input device 34.

In the illustrated embodiment, the server system 12 includes a system controller 36, a communications server 38, an audio/video server 40, a player tracking server 42, an event recognition server 44, a yield management server 46, a database server 48, and a database 50. The servers 38, 40, 42, 44, 46, and 48, system controller 36, and database 50 are connected through a network 52 such as, for example, a local area network (LAN), a wide area network (WAN), dial-in-connections, cable modems, wireless modems, and/or special high-speed Integrated Services Digital Network (ISDN) lines. Moreover, at least one administrator workstation 54 is also connected to the network 52 to enable communication with the server system 12.

The communications server 38 communicates with the user computing devices 14 and the administrator workstation 54 to facilitate transmitting data over the network 22 via the Internet and/or the cellular network 24, respectively.

The database server 48 is connected to the database 50 to facilitate transmitting data to and from the database 50. The database 50 contains information on a variety of matters, such as, for example, observation areas, event selection areas, selection area states, event selection area conditions, triggering conditions, monitoring events, area characteristics, gaming metrics, event records, image characteristics, observation area conditions, modification/corrective actions, historical trend data, predictive trend data, user profile accounts, player tracking accounts, wagers, wager amounts, wager types, average wagers per game, and image data for producing graphical interfaces and/or screens on the user computing device 14 and temporarily stores variables, parameters, and the like that are used by the system controller 36. In one embodiment, the database 50 includes a centralized database that is stored on the server system 12 and is accessed directly via the user computing devices 14. In an alternative embodiment, the database 50 is stored remotely from the server system 12 and may be non-centralized.

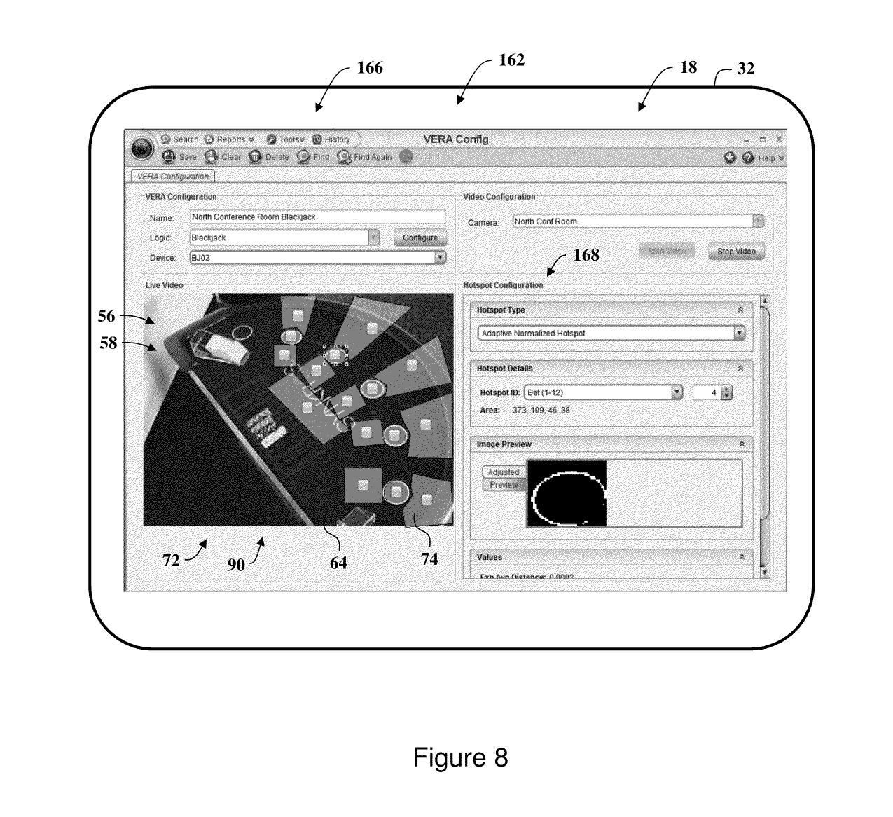

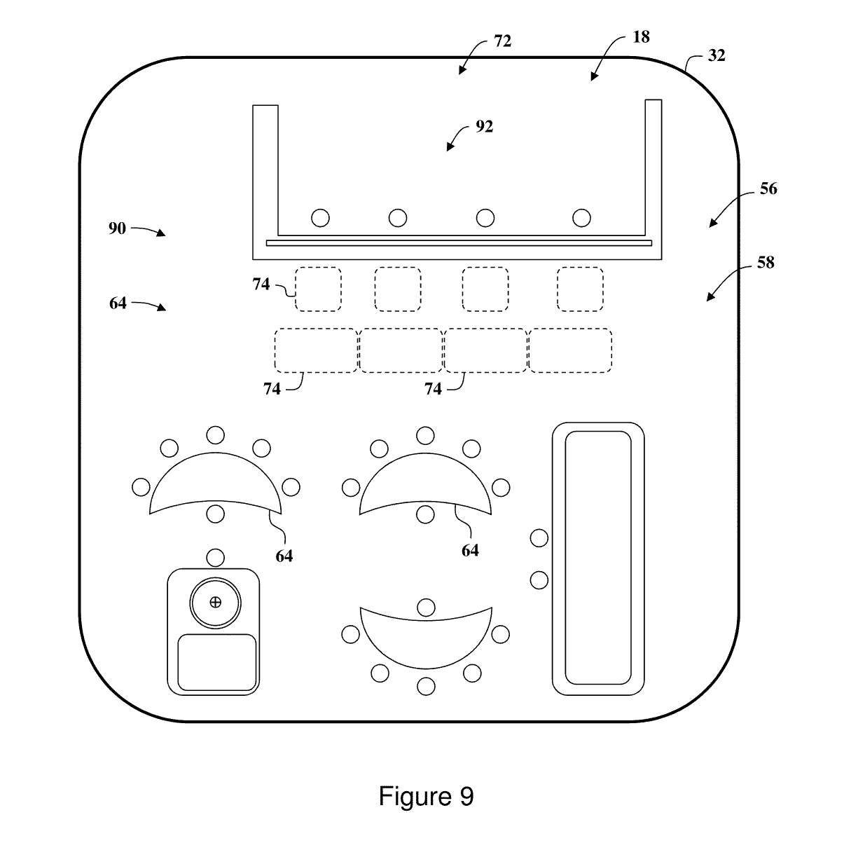

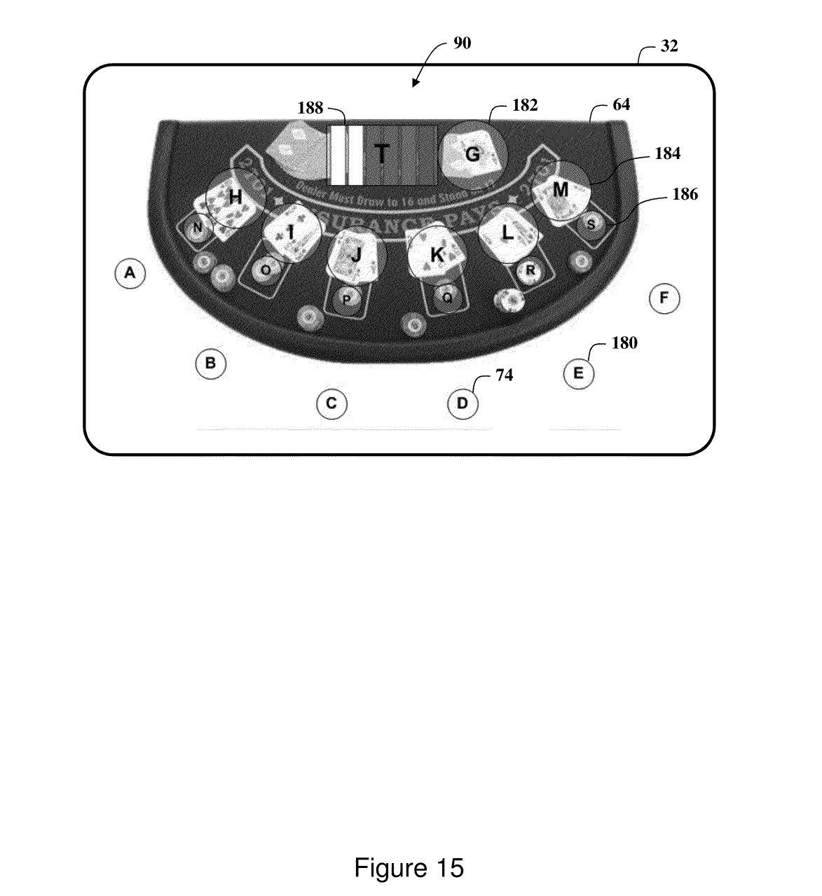

The audio/video server 40 is configured to broadcast images of live video images of an observation area to the event recognition server 44 and to the user computing devices 14 to allow users to view streaming video images of an observation area 56 of a gaming environment 58. In the illustrated embodiment, the audio/video server 40 is connected to an image broadcast system 60 that is configured to generate video images of the observation area 56. In one embodiment, the image broadcast system 60 includes an imaging device 62 such as, for example, a video camera that is configured to capture and transmit images of the observation area 56. The audio/video server 40 may be configured to receive a plurality of live video images from a plurality of imaging devices 62 positioned at various locations through the monitored environment. In one embodiment, the observation area 56 may include a gaming table 64 (shown in FIGS. 8 and 15). In another embodiment, the observation area 56 may include a portion of a casino floor 66 including a plurality of gaming tables 64 (shown in FIG. 9) and/or any portion of an environment that is being monitored by the system 10. In the illustrated embodiment, the audio/video server 40 is configured to receive and record the images from the image broadcast system 60 and transmit the images to the event recognition server 44. In addition, the audio/video server 40 may delay the broadcast of the live video image for a predefined period of time, and/or broadcast a prerecorded live video image to the event recognition server 44 and/or the database 50 for storage.

The system controller 36 is configured to controller the operations of the system 10 including operations performed by the communications server 38, the audio/video server 40, the player tracking server 42, the event recognition server 44, and the yield management server 46. The system controller 36 includes a processor 68 and a memory device 70 that is coupled to the processor 68. The memory device 70 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the processor 68 to store, retrieve, and/or execute instructions and/or data.

The processor 68 executes various programs, and thereby controls other components of the server system 12 and the user computing device 14 according to user instructions and data received from the user computing devices 14. The processor 68 in particular displays the graphical interfaces 18 and executes a operating program, and thereby enables the system 10 to generate area characteristics and/or gaming metrics associated with the observation area 56 and generates and display information associated with the observation area 56 in response to user instructions received via the user computing devices 14 in accordance with the embodiments described herein. The memory device 70 stores programs and information used by the processor 68. Moreover, the memory device 70 stores and retrieves information in the database 50 including, but not limited to, image data for producing images and/or screens on the display device 32, and temporarily stores variables, parameters, and the like that are used by the processor 68.

In the illustrated embodiment, the event recognition server 44 receives video image data from the audio/video server 40 a displays the video image data in a display area 72 (shown in FIGS. 8, 9, and 15) on the display device 32. The event recognition server 44 also displays a plurality of event selection areas 74 within the display area 72 and monitors a state of each event selection area 74. The event recognition server 44 also detects a change of state within the event selection area 74, determines a monitoring event associated with the state change, generates a monitoring event records, and transmits a signal indicative of the monitoring event record to the yield management server 46. The event recognition server 44 may also display a notification message on the display device 32 that is indicative of the generated monitoring event record. In one embodiment, event records may be indicative of game play at a gaming table 64. The event records may include, but are not limited to, dealer hand played, dealer hand removed, player hand played, player hand removed, bet/wager placed, bet/wager removed, betting chip removed, betting chip placed, position occupied, position not occupied, and/or any suitable event record that enables the system 10 to function as described herein.

The yield management server 46 receives monitoring event data from the event recognition server 44 and determines an area characteristic and/or gaming metric associated with the observation area 56 as a function of the received monitoring event data. The yield management server 46 may also determine a condition of the observation area 56 as a function of the determined area characteristics and/or gaming metric, and display a notification indicative of the determined condition on the display device 32. The area characteristic may include, but is not limited to, gaming metrics associated with game play, person occupancy levels, condition changes associated with the observed environment, and/or any suitable characteristic that may be associated with a changes and/or modifications of an observed environment. Modification of an observed environment may include, but are not limited to, lighting changes within an area, movement and/or appearance of objects and/or persons with the environment, and/or the appearance and/or movement of lighting effects such as, for example, shadows and/or lighted objects. Gaming metrics may include, but are not limited to, gaming table occupancy, table occupancy rates, area occupancy, table chip tray counts, dealer hand counts, dealer hands per hour, games played per hour, patron play percentage, patron hand win/loss, patron skill level, table, table revenue, area revenue, and/or any suitable gaming metric.

The yield management server 46 may also generate historic characteristic trend data as a function of the received area characteristic data and display the historic characteristic data on the display device 32. The yield management server 46 may also generate a set of area modification actions and/or corrective actions as a function of the historic characteristic data and generate and display predictive area characteristic data as a function of the historic characteristic data and the set of area modification/corrective actions.

The player tracking server 42 receives player tracking data from the player tracking system 16 and transmits the player tracking data to the yield management server 46. The yield management server 46 associates the player tracking data with the monitoring event data and/or the generated area characteristics data to update a player tracking account associated with the player tracking data.

In the illustrated embodiment, the workstation 54 includes a display and user input device to enable an administrative user to access the server system 12 to transmit data indicative of the triggering conditions, event selection areas, monitoring events, area characteristics, gaming metrics, player tracking events, area conditions, and/or observation areas to the database server 48. This enables an administrative user to periodically update the monitoring date and information that enables the system 10 to function as described herein.

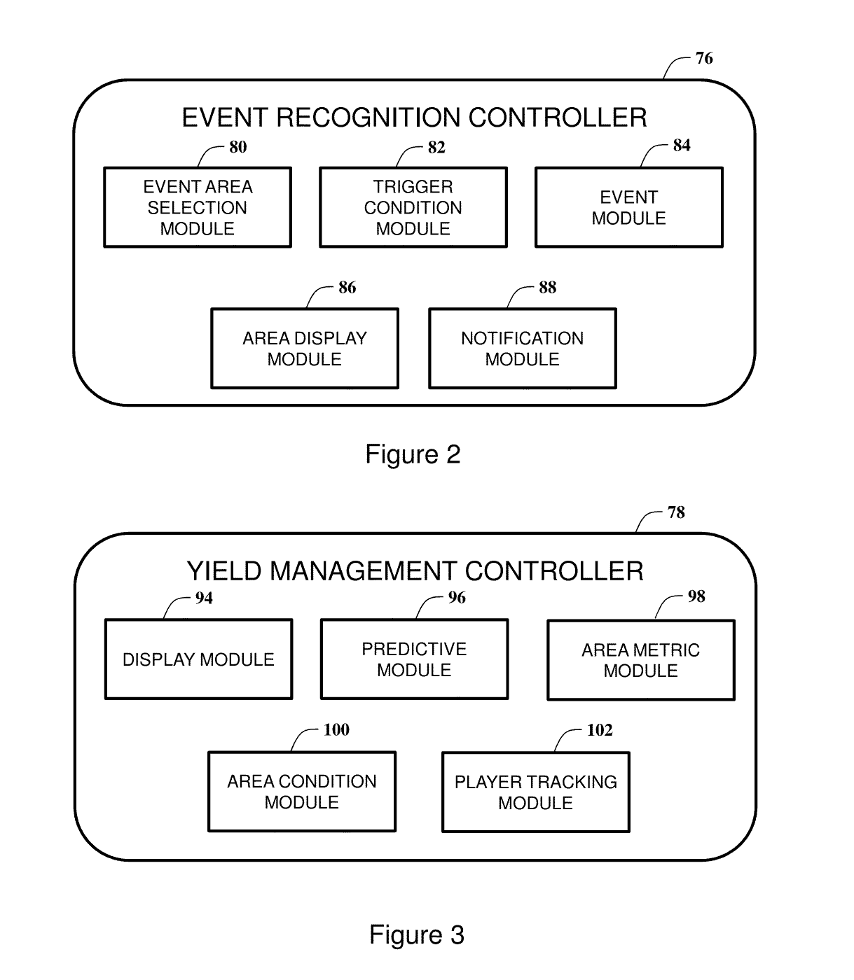

FIG. 2 is schematic view of an event recognition controller 76 that may be used with the event recognition server 44. FIG. 3 is schematic view of a yield management controller 78 that may be used with the yield management server 46. The event recognition controller 76 and the yield management controller 78 may each include a processor and a memory device (not shown). In addition, the system controller 36 may be configured to perform all or part of the functions of the event recognition controller 76 and/or the yield management controller 78 as described herein.

In the illustrated embodiment, the event recognition controller 76 includes an event area selection module 80, a triggering condition module 82, an event module 84, an area display module 86, and a notification module 88.

The area display module 86 is configured to receive a live video image 90 indicative of an observation area 56 from the audio/video server 40 and display the live video image 90 on a display area 72 (shown in FIGS. 8, 9, and 15). The live video image includes a plurality of image characteristics including, but not limited to, a brightness level, a contrast level, a color, a brightness, a contrast, a resolution, an amount of pixels, a pixel arrangement, and/or any suitable image characteristic that enables the system 10 to function as described herein. The area display module 86 may be configured to display a still image and/or a live video feed including a plurality of video frames on the display area 72.

The event area selection module 80 displays one or more event selection areas 74, e.g., “Hot Spots” in the display area 72. Each event area 74 extends over a portion of the video image 90. In the illustrated embodiment, the event area selection module 80 receives user input from the user input device 34 and displays one or more event selection areas 74 in response to the received user input.

The triggering condition module 82 detects a triggering condition associated with the event area 74 and transmits data indicative of the detected triggering condition to the event module 84. The triggering condition module 82 assigns a triggering condition to each of the event selection areas 74 and may assign the same and/or a different triggering condition to each of the event selection areas 74. The triggering condition may be defined as a change in an image characteristic within a corresponding event area 74. In one embodiment, the triggering condition module 82 may monitor at least one image characteristic associated with the event area 74 over a predefined period of time and determine a state of the event area 74 as a function of the monitored image characteristic. For example, the triggering condition module 82 may monitor and detect a level of brightness within the event area 74 over a predefined period of time and detect the triggering condition if the detected brightness level is different from a baseline brightness level. In one embodiment, for example, the triggering condition module 82 may detect the triggering condition if the brightness level within the event area 74 exceeds 50% over a period of time. In addition, the triggering condition module 82 may establish a baseline image characteristic as a function of the monitored image within the event area 74 over a period of time, and detect the triggering condition if a determined image characteristic is different from the baseline image characteristic. In addition, the baseline image characteristic may include a user defined image characteristic. For example, the triggering condition module 82 may monitor the brightness level associated with the event area 74 over a predefined period of time, determine an average brightness level as a function of the monitored brightness level, and determine the baseline brightness level as a function of the average brightness level.

In addition, the triggering condition module 82 may determine a first state associated with the event area 74 at a first period of time, determine a second state associated with the event area 74 at a second period of time, and detect the triggering condition if the second state is different from the first state. In addition, the triggering condition module 82 may determine a state change between the first state and the second state and detect the triggering condition if the determined state change is different from a threshold state change. Moreover, the trigger condition module 82 may define the triggering condition to include a change from the first state to the second state and back to the first state. For example, in one embodiment, the first state may include a first pixel arrangement and the second state may include a second pixel arrangement that is different from the first pixel arrangement. The triggering condition module 82 may define the triggering condition to include change from the first state to the second state, which may be indicative of an object entering the video image contained within the event area 74, and from the second state back to the first state, which may indicate an object leaving the event area 74.

The event module 84 is configured to receive the triggering condition data from the triggering condition module 82 and determine a monitoring event associated with the triggering condition and generate a monitoring event record associated with the monitoring event. For example, the event module 84 may assign a monitoring event to each of the triggering conditions generated by the triggering condition module 82, receive a signal indicative of the triggering condition, determine the monitoring event associated with the received triggering condition, and generate a corresponding event record. For example, in one embodiment, the observation area 56 may include a gaming table 64 (shown in FIGS. 8 and 15) and an event area 74 may be displayed over a player seating area associated with gaming table. The triggering condition module 82 may detect a triggering condition associated with the event area 74 including a change in the brightness level of the video image displayed within the event area 74, and transmit the triggering condition to the event module 84. The event module 84 may select a monitoring event associated with the received triggering condition and the associated event area 74. For example, the event module 84 may determine that a player is seated in the seating area as a function of the received triggering condition, generate an event record indicative of an occupied player position, and store the event record in the database 50. In addition, the triggering condition module 82 may generate another triggering condition associated with the event area 74 that is indicative of the brightness level within the event area 74 returning to a baseline level. The event module 84 may generate and store another event record indicative of an unoccupied player position and the player having left the corresponding seating area.

In another embodiment, referring the FIG. 9, the observation area 56 may include a casino floor including a plurality of gaming tables 64 and a casino cage area 92. The event area selection module 80 may display a plurality of event selection areas 74 within the display area 72 corresponding to locations adjacent to the casino cage 92 in response to a user request. The triggering condition module 82 may detect a change in brightness level associated with each event area 74 and transmit the triggering condition data to the event module 84. The event module 84 may generate and/or select a monitoring event associated with the triggering conditions that are indicative of a patron standing and/or walking adjacent to the casino cage area 92. For example, the triggering condition module 82 may detect a change in a brightness level within a event area 74 to a first brightness level that exceeds a threshold level and the event module 84 may generate a monitoring event record indicative of a patron standing in an area corresponding to the event area 74. The triggering condition module 82 may also detect a change in the brightness level to a second brightness level that is less than the first brightness level and is different from a baseline brightness level. The event module 84 may generate a monitoring event record indicative of the person exiting the observed area and leaving an article within the observed area.

The notification module 88 receives the monitoring event data from the event module 84 and displays a notice indicative of the monitoring event record on the display device 32. In addition, the notification module 88 transmits a signal indicative of the monitoring event record to the yield management server 46.

In the illustrated embodiment, the yield management controller 78 includes a display module 94, a predictive module 96, an area metric module 98, an area condition module 100, and a player tracking module 102. The display module 94 controls the display device 32 to display various images on the graphical interface 18 preferably by using computer graphics and image data stored in the database 50. The area metric module 98 receives monitoring event records from the event recognition server 44 and determines an area characteristic associated with the observation area 56 as a function of the determined monitoring event.

In addition, the area metric module 98 may determine one or more gaming metrics as a function of the event records. The area characteristics and/or gaming metrics may be indicative of characteristics associated with the observation area 56. For example, in one embodiment, the observation area 56 may include the gaming table 64 for use in playing card games. The area metric module 98 may receive a plurality of monitoring event records indicative of players being seated at corresponding player seating areas associated with a gaming table and generate gaming metrics that are indicative of game play associated with card games being played at the observed gaming table. For example, area metric module 98 may generate a gaming metric including a table occupancy level based on the number of event records indicative of occupied player positions. Moreover, in addition, the area metric module 98 may generate gaming metrics indicative of a number of games being player per hour as a function of the number of event records indicative of dealer hands being played over a predefined period of time. In addition, the area metric module 98 may update the table occupancy levels and/or the games per hour metric as additional monitoring event records are received from the event recognition server 44. The display module 94 may also display one or more notifications that are indicative of the determined area characteristics and/or gaming metrics on the display device 32.

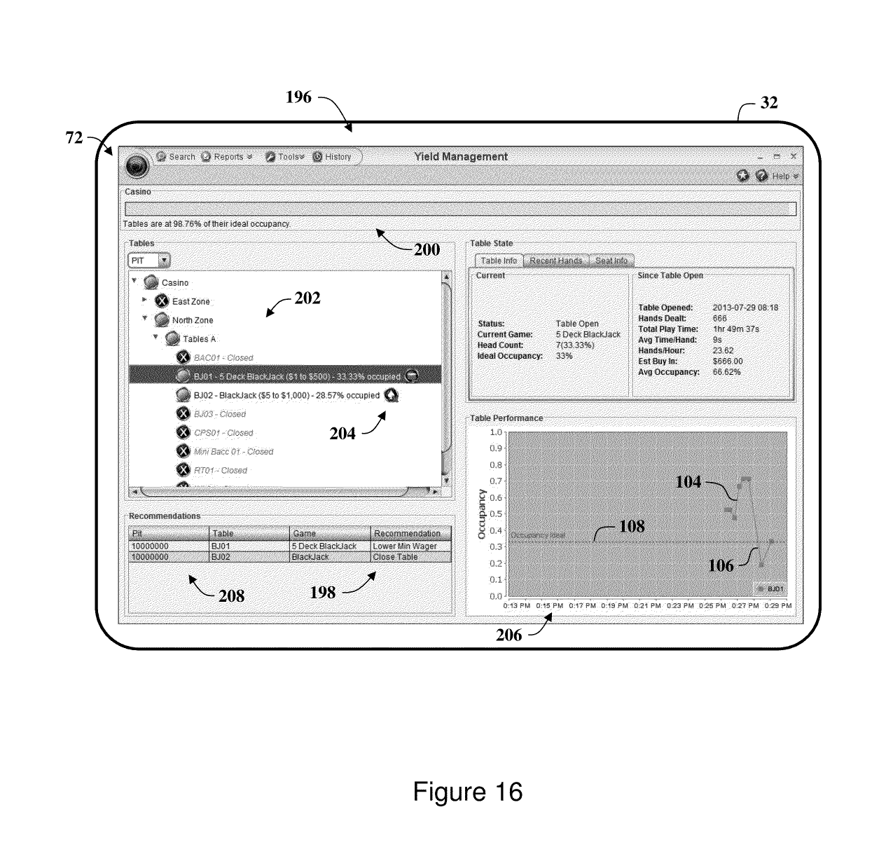

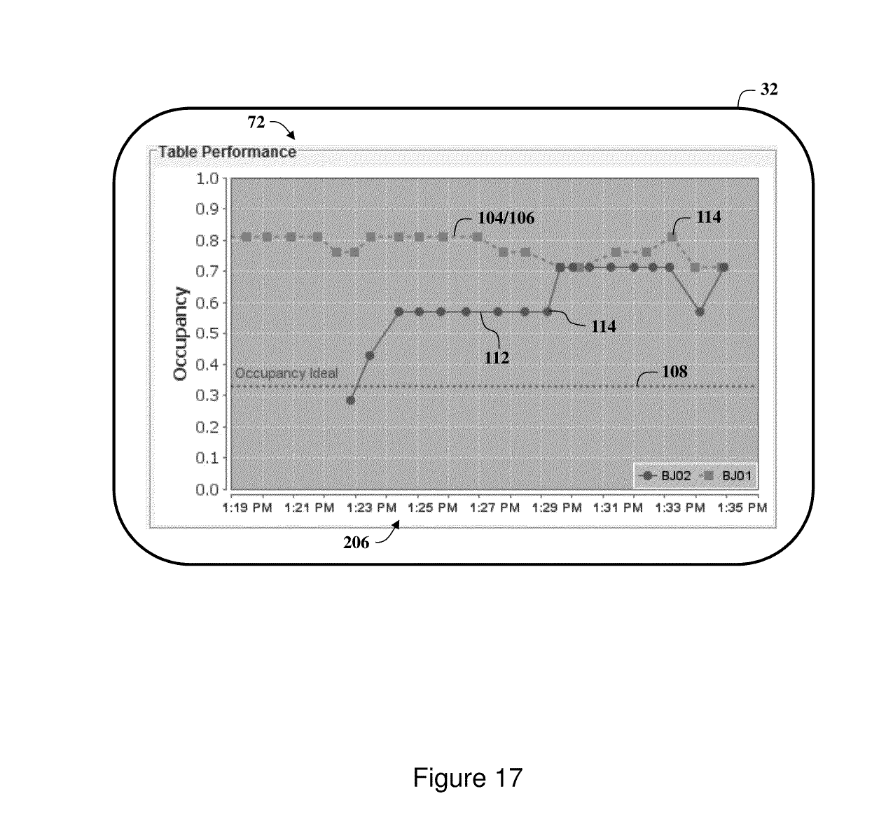

The area condition module 100 determines a condition of the observation area 56 as a function of the determined area characteristics and/or gaming metrics and displays a notification of the determined observation area condition on the display device 32. In addition, the area condition module 100 monitors the area characteristics and/or gaming metrics associated with the observation area over a period of time and generates current trend data sets including a set of gaming metric records that are indicative of gaming metrics determined at predefined time period intervals. Moreover, the area condition module 100 may generate historical trend data sets that include collections of previous trend data sets and/or gaming metric records corresponding to previous time periods. The area condition module 100 may also display a current trend trace 104 (shown in FIGS. 16 and 17) based on the set of current trend data that is indicative of a change in a corresponding gaming metric and/or area characteristic over time. Moreover, the area condition module 100 may display a predefined area condition and display the historic characteristic trend data simultaneously. For example, as shown in FIG. 17, the yield management server 46 may display a current table occupancy trend 106 over a predefined period of time, and display a target table occupancy level 108 to enable the user to quickly compare the current trend to the target level.

In addition, as shown in FIG. 17, the yield management server 46 may generate and display current table occupancy trend data for a plurality of observation areas 56 being monitored by the system 10. As shown in FIG. 17, the yield management server 46 may generate and display a first table occupancy trend 110 associated with a first monitored gaming table and a second table occupancy trend 112 associated with the second monitored gaming table.

In one embodiment, the area condition module 100 may select one or more corrective actions based on one or more gaming metrics and/or current trend data associated with a gaming metric. More specification, the area condition module 100 may determine the condition of the observation area 56 to be less than a predefined condition and select a modification/corrective action to adjust the current condition of the observation area 56 based on the difference between the current condition and the predefined condition. For example, in one embodiment, the area condition module 100 may determine the table occupancy of a gaming table 64 to be less than a predefined optimal table occupancy, and select a corrective action indicative of lowering a minimum table bet to facilitate increasing the table occupancy of the gaming table 64. In one embodiment, the corrective action may be selected from a predefined set of corrective actions including, but not limited to, open a gaming table, close a gaming table, raise minimum wager, and lower minimum wager. In addition, the area condition module 100 may compare the current gaming metric trend data with previous historical trends to identify a matching historical trend, determine a previous corrective action that is associated with the matched historical trend, and select a current corrective action that is similar to the previous corrective action associated with the historical trend.

In one embodiment, the area condition module 100 may determine area modification/corrective actions associated with changes in the area characteristics and/or gaming metrics and display the area modification actions with the trend data. For example, as shown in FIG. 17, the yield management server 46 may display the current characteristic trend data including the current trend trace 104 one or more nodes 114 that are indicative of corrective actions that have been initiated by the user and recorded by the yield management server 46. In one embodiment, the area condition

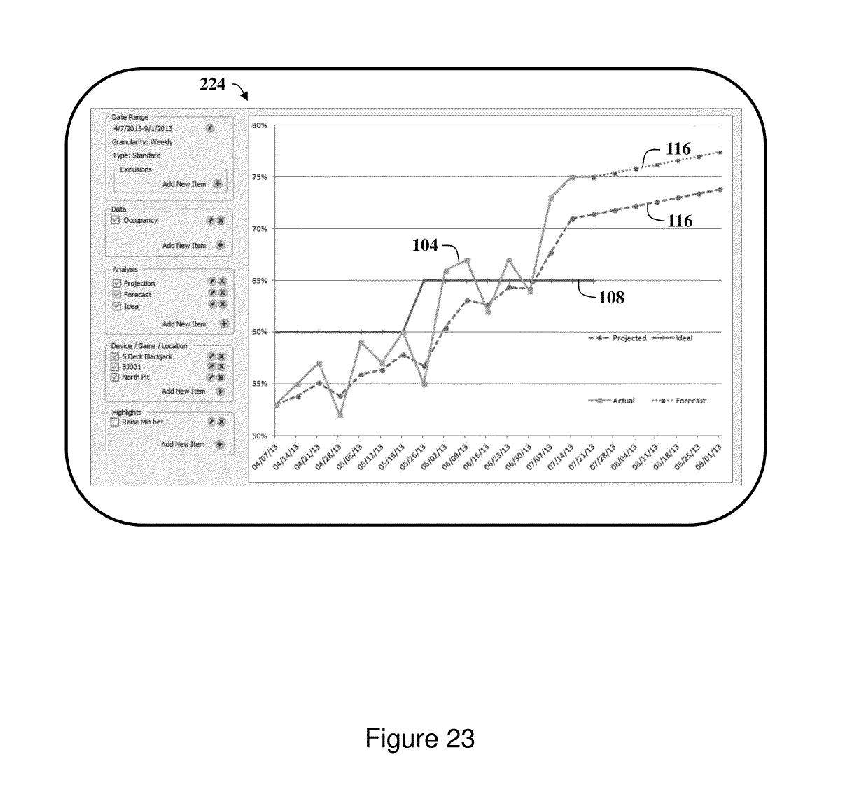

The predictive module 96 receives the historic characteristic trend data and generates predictive area characteristic data as a function of the historic characteristic trend data. The predictive module 96 may also display a predictive trace 116 (shown in FIG. 23) indicative of the predictive area characteristic data on the display device. In addition, the predictive module 96 may select an area modification/corrective action associated with the observation area 56, generate predictive area characteristic data as a function of the historic characteristic trend data and the selected area modification action, and display a predictive trace 116 indicative of the area characteristic data on the display device. For example, as shown in FIG. 23, the predictive module 96 may select an area modification action such as, for example, lowering a minimum bet, and generate predictive data indicative of predicted future table occupancy rates as a result of lowering the minimum bet level at the gaming table.

In addition, the yield management server 46 may store each historic characteristic trend data and predictive data in the database 50. The yield management server 46 may compare current area characteristic trend data with stored historic characteristic trend data to select area modification actions that may affect the current area characteristic trend, and generate and display predictive area characteristic data as a function of the selected area modification actions and the historic characteristic trend data.

The player tracking module 102 is configured to assign a player tracking account associated with the event area 74 in response to a user request, determine a player tracking event associated with the monitoring event, generate a player tracking record indicative of the player tracking event, and update the player tracking account as a function of the player tracking record. For example, in one embodiment, the player tracking module 102 may receive a monitoring event indicative of a player being seated at a gaming table, and assign a player tracking account to the corresponding event area 74. The yield management server 46 may track the period of time the seat is occupied by the player and generate a player tracking event indicative of the determined period of time. The player tracking module 102 may generate a player tracking record indicative of the player tracking event and transmit the player tracking record to the player tracking server 42 to update the corresponding player tracking account.

Additional details of exemplary entertainment and monitoring systems and/or player tracking systems, which may be used in the present invention, are disclosed in commonly owned, U.S. patent application Ser. No. 13/826,991, filed on Mar. 14, 2013, United States Patent Application Publication 2006/0058099A1, and United States Patent Application Publication 2003/0069071A1, all of which are hereby incorporated by reference.

FIG. 4 is a schematic representation of the player tracking system 16, according to an embodiment of the invention. FIG. 5 is a schematic representation of a device 118 that may be used with the player tracking system 16. In the illustrated embodiment, player tracking system 16 is configured to track patron events at a plurality of devices 118. In one aspect of the present invention the devices 118 may be gaming machines 120 or non-gaming machines 122. In one aspect of the present invention, the player tracking system 16 may receive information related to the player(s)' and/or patron(s)' use of the devices 118 and establish a player rating based thereon. The player rating may be a single number which reflects a value reflective of the player or patron's relative “worth” to a casino or resort. In one aspect of the present invention, the patron's relative worth may be first established with respect to a plurality of predetermined criteria.

In one embodiment, the player tracking system 16 may include additional functions such as, real-time multi-site, slot accounting, player tracking, cage credit and vault, sports book data collection, Point of Sale (POS) accounting, keno accounting, bingo accounting, and table game accounting, a wide area progressive jackpot, and electronic funds transfer (EFT).

As shown, the player tracking system 16 includes a plurality of devices 118. Devices 118 may include, but are not limited to gaming machines, electronic gaming machines (such as video slot, video poker machines, or video arcade games), electric gaming machines, virtual gaming machines, e.g., for online gaming, an interface to a table management system (not shown) for table games, kiosks 124, point of sale or redemption terminals 126, or other suitable devices at which a patron may interact or access a user or player account. In the illustrated embodiment, eight electronic gaming devices or machines (EGM) 120 are shown. However, it should be noted that the present invention is not limited to any number or type of machines 120. In one embodiment, the machines 120 are organized into banks (not shown), each bank containing a plurality of machines 120.

The devices 118 are connected via a network 128 to one or more host computers or servers 130, which are generally located at a remote or central location. The computer 130 includes a computer program application 132 which maintains one or more databases 134. In one embodiment, the database(s) are Oracle database(s).

The computer program application 132 and databases 134 may be used to record, track, and report accounting information regarding the gaming machines 120 and players of the gaming machines 120. Additionally, the computer program application 132 and database(s) 134 may be used to maintain information related to player or player tracking accounts 136 contained in the database 134.

In general, the machines 120 may be used by a user or player, i.e., to access their player account. For example, a gaming machine 120 is playable by a player 138. The player 138 may select one of the gaming machines 120 to play and insert a coin, credit, coupon, and/or player tracking card (not shown) into the chosen EGM 120. Generally, the gaming machines 120 have an associated number of credits or coins required in order to play. In the case of video slot or poker games, the game is played and an award in the form of credits may be awarded based on a pay table of the gaming machine 120.

Referring to FIG. 5, in one embodiment, the machine 120 comprises a game controller 140, or central processing unit (CPU), a coin-bill management device 142, a display processor 144, a RAM 146 as a memory device and a ROM 148 (generally provided as an EPROM). The CPU 140 is mainly composed of a microprocessor unit and performs various calculations and motion control necessary for the progress of the game. The coin-bill management device 142 detects the insertion of a coin or a bill and performs a necessary process for managing the coin and the bill. The display processor 144 interprets commands issued from the CPU 140 and displays desirable images on a display 150. The RAM 146 temporarily stores programs and data necessary for the progress of the game, and the ROM 148 stores, in advance, programs and data for controlling basic operation of the machine 120, such as the booting operation thereof, game code and graphics.

Input to the gaming device 120 may be accomplished via mechanical switches or buttons or via a touchscreen interface (not shown). Such gaming machines 120 are well known in the art and are therefore not further discussed.

The player 138 is identified via the player tracking card and/or a player identification number entered into player tracking device 152 at each EGM 120 (see below). Player tracking accounts may be used, generally, to provide bonuses to a player, in addition to the award designated by, in the case of a video slot or poker machine, the EGM's 120 paytable. These bonuses may be awarded to the player 138 based a set of criteria, including, but not limited to, a) the player's play on the machine 120, b) the player's overall play, c) play during a predetermined period of time, and d) the player's birthday or anniversary, or e) any other definable criteria. Additionally, bonuses may be awarded on a random basis, i.e., to a randomly chosen player or randomly chosen game. Bonuses may also be awarded in a discretionary manner or based on other criteria, such as, purchases made at a gift shop or other affiliated location.

In one embodiment, the player tracking device 152 includes a processor 154, a player identification card reader 156 and/or a numeric keypad 158, and a display 160. In one embodiment, the display 160 is a touchscreen panel and the numeric keypad 158 is implemented thereon.

The player 138 may be identified by entry of a player tracking card into the player identification card reader 156 and/or entry of a player identification number (PIN) on the numeric keypad 158. The player tracking device 152 may also be used to communicate information between the computer 140 and the corresponding EGM 120. The player tracking device 152 may also be used to track bonus points, i.e., incentive points or credits, downloaded from the computer 140.

Each device 118 has a value associated therewith. With respect to the gaming machines 120, the value is a theoretical hold percentage. The theoretical hold percentage may be defined as the casino or establishment's estimated, average revenue percentage. For example, if the gaming machine 120 is a slot machine, the hold percentage is the expect house's estimate, average take or revenue for a particular machine. For a non-gaming device 122, e.g., a point of sale terminal, such as a cash register, a restaurant, or a spa, the theoretical hold percentage may be set to an estimated profit percentage for the given device 118.

In one aspect of the present invention, each player tracking device 152 is associated with one of the electronic gaming machines 120. The player tracking devices 152 identify patrons interacting with the system 10, for track wagers made by the players on the electronic gaming machines 120 and record wager data associated with each wager made by the player and a respective electronic gaming machine 120. In one embodiment, the wager data includes a device type associated with respective gaming machine, an electronic gaming machine identifier, the theoretical hold percentage associated with the respective gaming machine, and an amount of the respective wager. The wager data may also include a player ID and a date/time stamp.

The computer or server 140 is in communication with the player tracking devices 152 and the non-gaming machines 122 for receiving the wager data associated with the patrons and the respective gaming machine 120 from the player tracking device 152 and storing the wager data in a database and, for receiving transaction data associated with a transaction associated with the patrons' use of the non-gaming devices 122 and storing the transaction data in the database. The computer also establishes a player rating associated with each player as a function of the wager data and the transaction data.

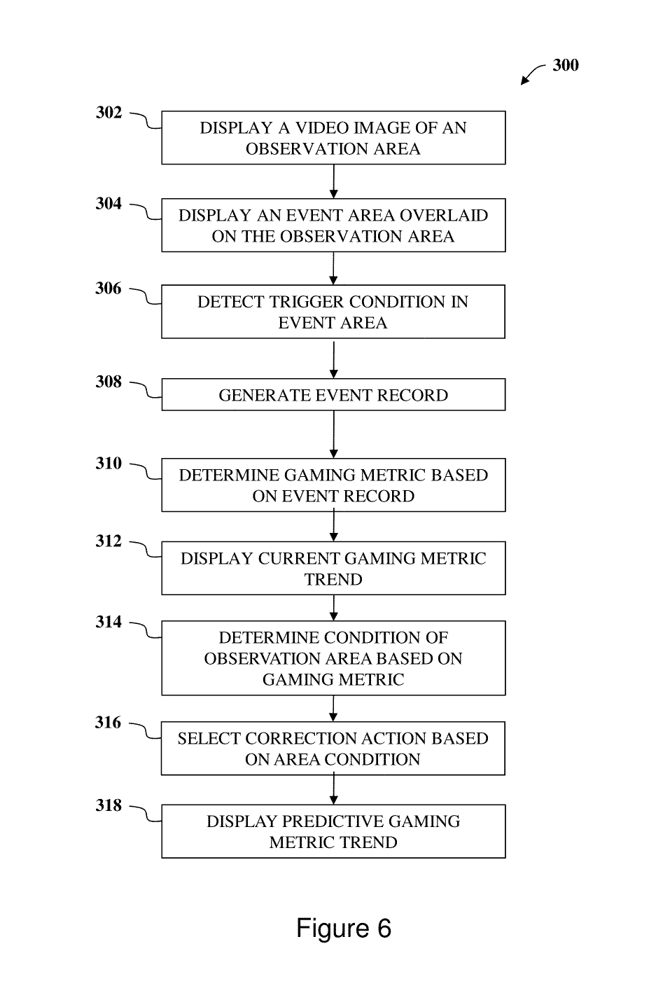

FIG. 6 is a flowchart of a method 300 that may be used with the system 10 for operating a gaming environment. The method 300 includes a plurality of steps. Each method step may be performed independently of, or in combination with, other method steps. Portions of the method 300 may be performed by any one of, or any combination of, the components of the system 10. FIGS. 7-24 are exemplary graphical displays of operating screens that may be displayed by the system 10, according to an embodiment of the present invention.

In the illustrated embodiment, in method step 302, the system controller 36 receives a live video image of an observation area 56 from the image broadcast system 60 and displays the image on the display device 32. The image 90 is displayed within a display area 72 of a monitoring screen 162. In one embodiment, the observation area 56 includes a gaming table 64 within a casino gaming environment that is used for playing card games such as, for example, blackjack, baccarat, poker, and/or any suitable wagering games.

In the illustrated embodiment, the live video image 90 includes a plurality of image characteristics that may be detected and monitored by the system controller 36. For example, the image characteristics may include, but are not limited to, image brightness, image contrast, image resolution, color, and/or any suitable image characteristics.

In method step 304, the system controller 36 displays an event area 74 within the display area 72 to facilitate monitoring a portion of the observation area 56. In the illustrated embodiment, the system controller 36 displays one or more event areas 74 that overlay portions of the video image displayed within the display area.

In one embodiment, the system controller 36 is configured to allow a system user such as, for example a casino employee select and modify the shape and/or location of one or more event areas 74 to allow the employee to determine the monitoring locations within the observation area 56. For example, in one embodiment, the system controller 36 may display an image setup screen 164 (shown in FIG. 7) to allow a user to identify one or more imaging device 62 to receive video images. The image setup screen 164 includes a form that allows the user to add new and change existing cameras and their configuration. Users are be able to create new rows by hitting an insert key on the keyboard. The Mode column includes a dropdown menu with the values PUSH and PULL. When new records are inserted, only the Name, URL, Mode, and optional Username and Password may be filled. The system controller 36 may save the records in the database 50 with the first ID column and the last two columns automatically populated. Updating any row may also result in updated values in the last two columns including identification of the user modifying the record and the date modified.

The system controller 36 may also display an event area configuration screen 166 (shown in FIG. 8) to allow a user to generate and display an event area 74 overlaying the live video image 90. The system controller 36 allows a system user to search the database 50 for previous event areas 74. Using a FIND command, the system user can search the database 50x and find an event area configuration, e.g., VERA configuration by name, logic interface, or device. Creating a new event area 74 configuration may require a unique name, as well as a unique logic and device combination. In the FIND dialog there may also be a column called Status that is either STOPPED or RUNNING, which indicates what the current state of the event area configuration. When a configuration is changed and saved while it is running, which the status will indicate, the user will be required to go to a VERA Control form and force an update manually. The Video Configuration section allows the system user to select a previously defined IP camera and start/stop the video feed into the form, which will appear under Live Video section.

The event area configuration screen 166 includes an event area configuration section that allows a user to generate and/or modify one or more event areas 74. The Live Video panel allows a user to interact with the editor, adding new event areas 74, e.g., Hotspots, resizing, moving, rotating, skewing, duplicating, and more. Most interactions are done via a context sensitive selection menu. The Hotspot Configuration Panel 168 allows a user to change individual hotspot/event area 74 data as the user interacts with the editor. By selecting on the live video in an empty (not over an existing hotspot), the system controller 36 displays a default selection menu, allowing the user to add new hotspots having three different shapes: Rectangular, Ellipse, and Polygon. Once the user has drawn a hotspot/event area 74, it is automatically selected, which is indicated by a dashed black and white line that animates around the hotspots shape. After the user has drawn a hotspot/event area 74 and it is selected, the system controller 36 displays a new selection menu that contains many different options associated with the event area 74. When the user has selected a hotspot/event area, the user may choose to redraw a selected hotspot. In addition, while a hotspot or a group of hotspots are selected the user is able to move the hotspots in several ways. Dragging hotspots around is done by placing the mouse over the selected area until the drag cursor is visible and then simply selecting and dragging the hotspot around the display area 72. Left, right, up, and down arrows can be pressed to move a hotspot one pixel in a corresponding direction. The user may also press and hold the Shift key while pressing any of the arrow keys to move the hotspot in that direction by ten pixels.

A hotspot/event area 74 may be duplicated by either selecting on single or multiple selected hotspot(s) and selecting the Duplicate Hotspots menu option or by the key-shortcut of CTRL+C followed by CTRL+V. After duplication, exact copies will be visible down and to the right of where the hotspots were located at the time of duplication or copying. If the user copies a hotspot with CTRL+C and later moves or delete it, pasting it with CTRL+V will still duplicate the hotspot where it was and as it was at the time it was copied. After duplication, a hotspot may have a validation warning indicated in the center of the hotspot as a red exclamation point (!).

On the selected hotspot(s) selection menu are the transform operations Scale, Rotate, and Skew. These all make use of the transform handles visible in the four corners and four edges of the selected hotspot. Scale operation will resize all selected hotspots in the direction as indicated by the cursor and transform handle position. By default, scaling is performed relative to the opposite transform handle. In the case of the picture to the right, scaling is performed on the north-east corner and will be scaled locked to the south-west corner. Pressing and holding the ALT key while dragging the mouse will instead scale the hotspot from its center, causing the opposite side to move at the same time and in the opposite direction of the transformed corner. Pressing and holding the Shift key while dragging the mouse will constrain the aspect ratio as the user drags the transform handles, preventing the user from distorting the original shape. The Rotate operation rotates all selected hotspots in the direction the transform handle is dragged. The cursor becomes a circular arrow indicating that the user is in rotation mode. Pressing and holding the Shift key while dragging the mouse will lock the rotation to 15 degree increments. A small target icon is displayed in the center of the selected hotspot(s). This symbol represents the center of the rotation transformation. By default, this icon will always start out at the center of the selected area and is why rotations will by default rotate around the center of the selected area. The Skew operation distorts a selected event area 74 by skewing or shearing it. Skewing always results in an equal and opposite reaction on the opposite corner. The Mirroring operation allows the user to flip a hotspot in both the horizontal, vertical, or both directions at once.

The system controller 36 allows a user to export and/or import stored event areas 74 onto a current observation area video configuration. Exporting will pop-up a save-file dialog that will allow the user to save all of the hotspots to the selected folder and named file. Once finished a popup will appear showing the final saved location. Importing will pop-up a browse-file dialog that will show XML files. When the user selects an XML file details about the file, assuming it is valid, will appear in the window to the right of the file list.

The system controller 36 may display event areas 74 including several different types to perform different purposes depending on the required need. In general, event areas 74 may include motion hotspots for detecting motion and adaptive normalized hotspot for detecting change in a controlled environment. For example, event areas 74 may include a motion detection hotspot, a motion trigger hotspot, an adaptive normalized hotspot, and/or an advanced motion hotspot. The motion detection hotspot triggers from motion and then absorbs the change. The motion trigger hotspot trigger from motion and then remains triggered. The adaptive normalized hotspot detects contrast change, absorbs noise, and attempts to adapt for significant variation. The advanced motion hotspot detects motion and triggers based on the configuration settings.

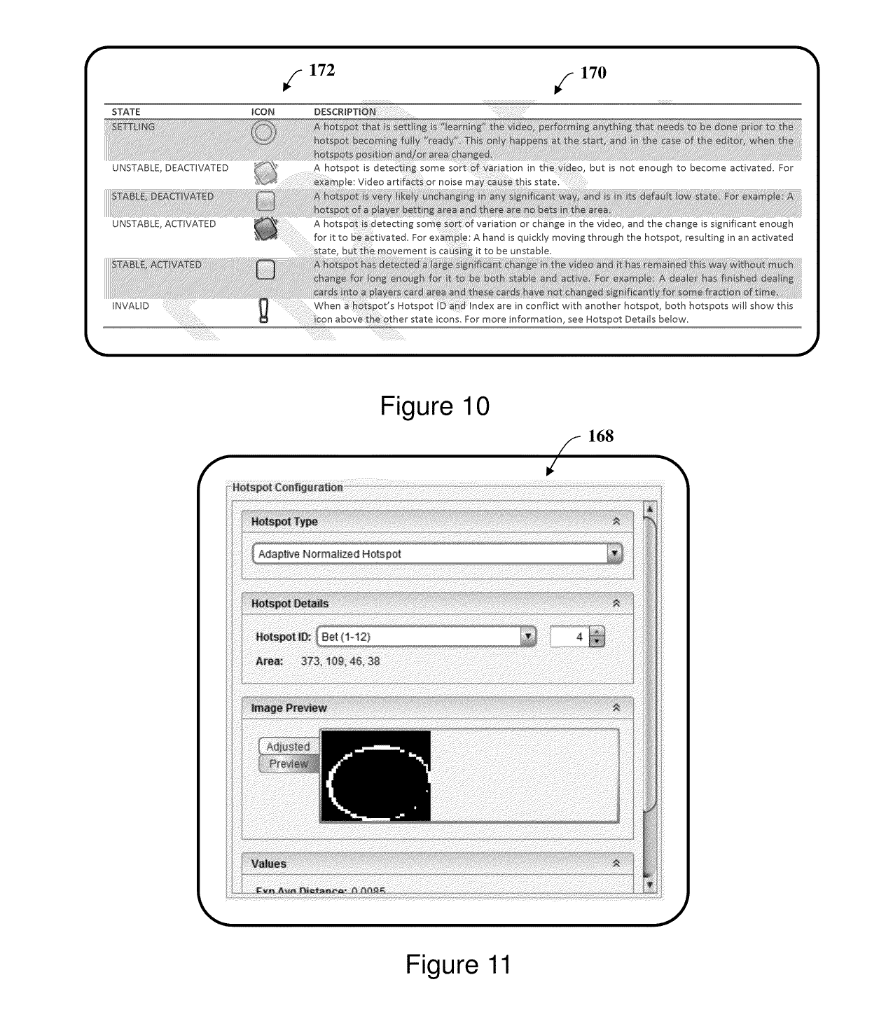

The system controller 36 may also display a state indicator 170 associated with each event area 74. Each hotspot/event area 74 may also have a state which is represented on an editor panel 172 (shown in FIG. 10). These states are used to determine what actions need to happen when specific hotspots are in a specific set of states.

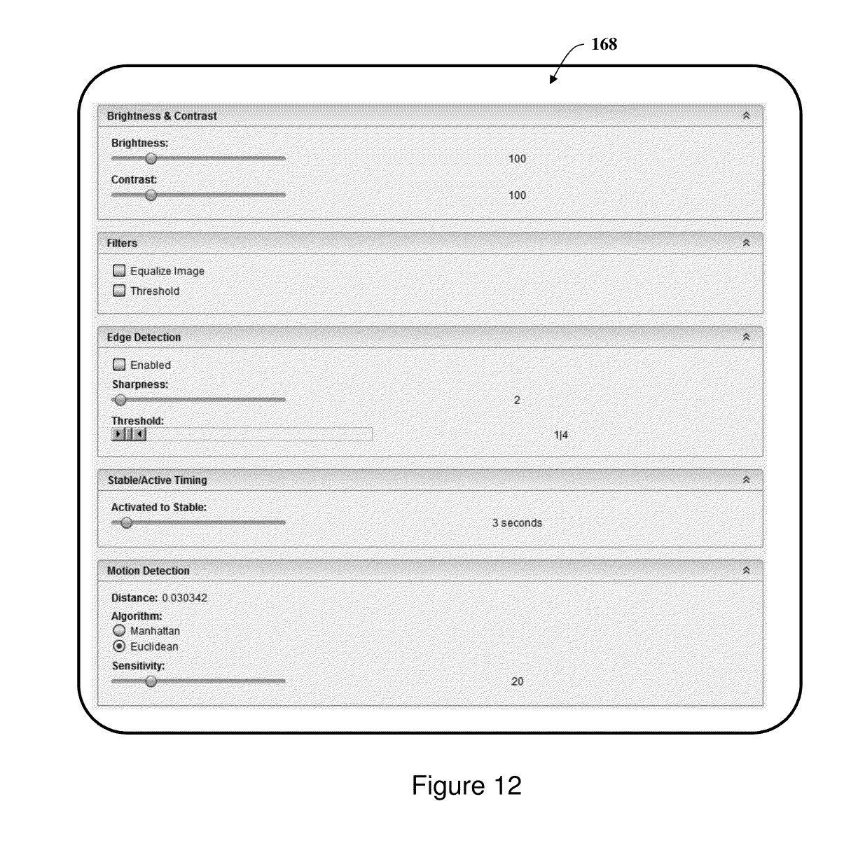

The Hotspot Configuration Panel 168 (also shown in FIGS. 11 and 12) allows a user to change individual hotspot/event area 74 data such as, for example type, name and index, image processing, etc. Hotspot Type: when a single hotspot is selected, the dropdown changes to indicate the type of the hotspot. Changing this will then change the type of the hotspot. Changing hotspots from one type to the other is allowed, and any configuration options you have set will be retained across type switching. Hotspot Details: this configuration group exists for all hotspots and becomes visible when the user has selected a single hotspot. Here the user can change the Hotspot ID as well as the Index of the hotspot. These are used to indicate precisely what the hotspot in question indicates. The system controller 36 also displays the area of the hotspot in pixels, indicating the X position, Y position, Width, and Height of the hotspot. Image Preview: allows a user to see only the portion of the video contained by the hotspot/event area 74. Adjusted video will show any post-processing done on the video, such as adjusting brightness or contrast, filters, and edge detection. Preview will show an internal representation of how the hotspot is interpreting the video for detection.

Motion Hotspot Configuration. The system controller 36 may display a event area configuration screen 166 that allows the user to modify the properties associated with the hotspot/event area 74. Both the Motion Detection Hotspot and the Motion Trigger Hotspot share the same configuration options. Brightness and Contrast: changes the tonal range of the video. Filters: Equalize Image will adjust the image so that the black to white ratio of the image is equal; Threshold finds the average brightness of the video and converts pixels less than this to black and pixels greater than this to white. Edge Detection: finds the edges (areas with strong intensity contrasts) of an image. Stable/Active Timing: adjusts how long a hotspot need be active until it is considered stabilized. Motion Detection: Distance indicates the average change between pixels of the current video and previous frames; Algorithm: Manhattan weighs the average change equally across all pixels, Euclidean weights larger change between pixels more heavily; Sensitivity indicates the distance value (in tenths of a percent) that needs to be reached for a hotspot to be considered active.

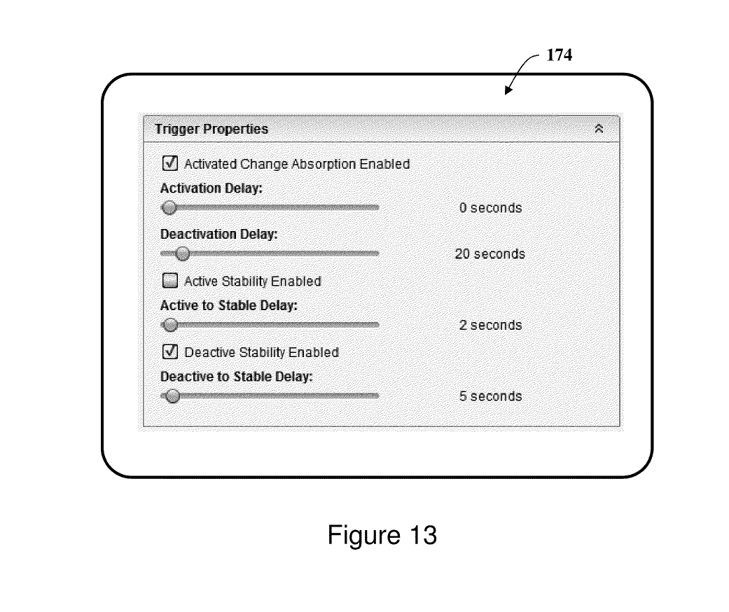

The system controller 36 may also display a trigger properties screen 174 (shown in FIG. 13) to allow a user to adjust the triggering conditions associated with an event area 74. Advanced Motion Hotspot Trigger Properties: these options allow the user to specify precisely how motion will trigger a hotspot/event area 74. These allow for very precise and yet flexible detection. Activated Change Absorption Enabled, when checked, will absorb change once a hotspot is active. This means that if something changes in the hotspot, activating it, and then stops moving, the hotspot will deactivate. Activation Delay is how long it will take for a hotspot to become activated after the distance is above the configured sensitivity. Deactivation Delay is how long it will take for a hotspot to deactivate (from activated) once a hotspot drops below its configured sensitivity value. Active Stability Enabled determines if a hotspot should immediately become stable after it activates. Active to Stable Delay is how long after a hotspot becomes active should it then be considered stable. Deactive Stability Enabled determines if a hotspot should immediately become stable after it deactivates. Deactive to Stable Delay is how long after a hotspot becomes deactivated should it take to then be considered stable.

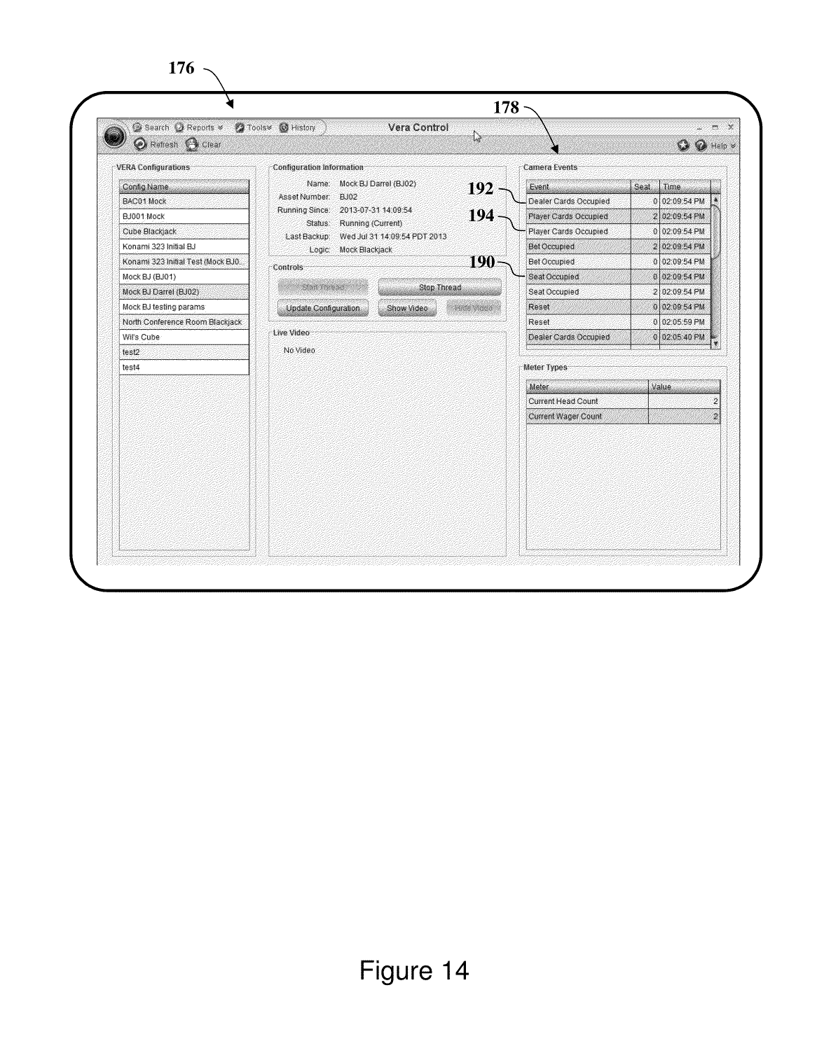

In one embodiment, the system controller 36 may display a Controls screen 176 (shown in FIG. 14) to allow the user to assign one or more event records 178 to a corresponding event area 74. Upon detecting a triggering condition associated with the event area 74, the system controller 36 will responsively generate the corresponding event record 178. The Configuration Information provides the user the name and status of the configuration, as well as when the configuration began running, what the most current configuration version is, when the last time the running configuration was automatically backed up for restoring purposes, as well as the logic interface being utilized. The Controls screen 176 allows the user to control the selected VERA Configuration and control the Live Video preview panel including assign an event record 178 to a corresponding event area 74. Camera Events: Camera Events shows a list of the last (X) number of events, updating in real time as they occur. Meter Types shows the user the meters/gaming metrics tied to that VERA Configuration and gives the user real time values of the gaming metrics.

In method step 306, the system controller 36 detects a triggering condition associated with the event area 74. In the illustrated embodiment, the triggering condition is defined as a change in an image characteristic within the event area 74. For example, in one embodiment, the system controller 36 may detect a triggering condition if the a brightness level within an event area 74 is above a predefined brightness level and/or the brightness level is changed from the predefined brightness level to indicate an object has entered and/or has been removed from an area of the live video image associated with the event area 74.

In method step 308, the system controller 36 generates an event record 178 upon detecting the triggering condition. For example, upon detecting the triggering condition, the system controller 36 may determine the event record 178 associated with the event area 74 and generate and store the event record 178 indicative the time in which the event record 178 occurred.

In method step 310, the system controller 36 determines a gaming metric associated with the event record 178 and displays a notification indicative of the gaming metric on the display device 32. For example, as shown in FIG. 15, the system controller 36 may display the live video image 90 including a gaming table 64 located within a casino gaming environment. In addition, the system controller 36 may display a plurality of event areas 74 including one or more position event areas 180 (position A, B, C, D, E, and F), a dealer event area 182 (position G), one or more a player hand event areas 184 (position H, I, J, K, L, and M), one or more player betting event areas 186 (position N, O, P, Q, R, and S), and/or a chip tray event area 188 (position T). The dealer event area 182 overlays a corresponding dealer hand location on the gaming table 64 that is used for positioning a plurality of playing cards associated with a dealer's hand during a card game. Each player hand event area 184 is positioned over a corresponding player hand location on the gaming table 64 that is used for placing playing cards associated with a player's hand during the card game. The position event areas 180 overlaps a corresponding player position, e.g., player seating area. The player betting event areas 186 extends over a corresponding player betting area used by player's to place betting chips. The chip tray event area 188 is positioned over the dealer's chip tray that is used to store betting chips for use during the game.

In one embodiment, system controller 36 may display a plurality of position event areas 180 in the display area 72, monitor each of the position event areas 180 and generate a position event record 190 (shown in FIG. 14) associated with a corresponding position event area 180 upon detecting a corresponding triggering condition. Each position event record 190 may be indicative of a player occupying the corresponding player position. In addition, the system controller 36 may determine the gaming metric including a gaming table occupancy level as a function of the generated position event records 190. For example, the following steps can collect data to determine the Table Occupancy in real-time. The system controller 36 sets up an “Event Area” in positions A, B, C, D, E and F and establishes an “Action” for each “Event Area”. When the visual “Event” is triggered by the system reacting to a configurable change in view, the “Action” can toggle an “Occupancy” flag between 1 and 0 (1=occupied, 0=not occupied) and update the status in a database. The current state of occupancy can be determined real-time by a simple query to the database monitoring the “Occupancy” flag. For instance, if positions A, B, E and F are occupied when the system queries, the occupancy (or head count) at that time would be 4, noting there are 2 empty seat available for play (in this configuration based on a six seat gaming table).

By collecting the occupancy information automatically, the Table Games Management System will maximize Table Play while reducing the human error factor. Internal or External Yield Management Software can query the data for: determining if additional tables need to be opened, or existing tables should be closed, optimizing the minimum bet requirements as play increases or decreases, and optimizing staffing requirements as play increases or decreases.

The system controller 36 may also detect a triggering condition associated with the dealer event area 182 and generate a dealer event record 192 (shown in FIG. 14) indicative of a dealer hand being dealt during game play upon detecting a triggering condition associated with the dealer event area 182. In addition, the system controller 36 may determine a number of dealer event records 192 that have been generated over a predefined period of time, and determine the gaming metric including an average number of dealer hands played as a function of the determined number of dealer event records 192. For example, the system controller 36 may be configured to determine the table Hands Per Hour (by the dealer) in real-time by establishing the dealer event area 182, assigning a dealer event record 192 indicative of a dealer hand being dealt to the dealer event area 182, and generating the dealer event record 192 when the visual Event is triggered. The following steps can collect data to determine the table Hands Per Hour (by the dealer) in real-time. The user sets an “Event Area” in position G and sets an “Action” for the “Event Area”. When the visual “Event” is triggered by the system reacting to a configurable change in view, the “Action” can toggle an “Hand Played” flag between 1 and 0 (1=Play Started, 0=Play Ended). The system controller 36 monitors the changes as determined by the “Action” and records the count of changes. The system controller 36 may also calculate and record the current rate of “Hand Per-Hour” (by the dealer) in the database. For instance, if position G changed state 55 time in an hour, a rate of 55 Hands Per-Hour would be annotated in the database for that Table Game.

By collecting the hands per-hour information automatically, the Table Games Management System will increase its accuracy of patron table ratings that are based on Average Wager amount times Hands Per Hour. By collecting the hands per-hour information automatically, the Table Games Management System will be able to accurately rate the Dealer performance in relation to the table hold percentages. By collecting the hands per-hour information automatically, the Table Games Management System will be able to more accurately rate the Patron activity in relation to the table hold percentages.

In one embodiment, the system controller 36 may determine patron play percentage including generating a player hand event record 194 indicative of a player hand being dealt during game play upon detecting a corresponding triggering condition associated with the player hand event area 184. The system controller 36 may determine the gaming metric including the patron play percentage as a function of the player hand event record 194 and the dealer event record 192. The patron play percentage may be indicative of a percentage of dealer hands being played by a corresponding player. In addition, the system controller 36 may determine a player account associated with the corresponding player, and determine a player rating associated with the corresponding player account as a function of the patron play percentage. For example, the following steps can collect data to determine the Patron Play Percentage in real-time. The system controller 36 sets an “Event Area” in position G, sets an “Action” for that “Event Area” to monitor Total Hands Per Hour by the dealer (as described above), sets an “Event Area” in positions A, B, C, D, E and F, sets an “Action” for each of those “Event Areas” to Monitor Table Occupancy (as described above), sets an “Event Area” in positions N, O, P, Q, R and S, and sets up an “Action” for each of those “Event Areas”. When the visual “Event” is triggered by the system reacting to a configurable change in view, the “Action” can toggle an “Hands Play (by the Patron)” flag between 1 and 0 (1=Playing, 0=not Playing) and update the status in a database. By comparing the state of occupancy, the state of the dealer playing a hand, and the state of the player in a seat actually playing the hand as well, you can determine the Patron Play Percentage. For instance, if positions “A” is occupied 7 times during 10 dealer hands, the play percentage for position “A” would be 70%.

Patron Play Percentage information is critical to the Patron Rating process that is used for marketing compensatory rewards, for forecasting of Table Games personnel resources as well as minimum bet requirements on the Gaming Table, Pit Area, or Total Gaming Area as a whole. By collecting the Patron Play Percentage information automatically, the Table Games Management System will maximize Table Play while reducing the human error factor. Internal or External Yield Management Software can query the data for: more accurately awarding marketing compensatory paybacks based on actual table play, determining if additional tables need to be opened, or existing tables should be closed, optimizing the minimum bet requirements as play increases or decreases, and optimizing staffing requirements as play increases or decreases.

The system controller 36 may also determine Patron Hand Win/Loss. For example, the following steps can collect data to determine the Patron Hand Win/Loss in real-time. The system controller 36 may be configured to set an “Event Area” in position G, set an “Action” for that “Event Area” to monitor Hands Played (by the dealer as described above), set an “Event Area” in positions N, O, P, Q, R and S, set an “Action” for that “Event Area” to monitor “Hands Played (by the Patron as described above), set an “Event Area” in positions H, I, J, K, L and M, and set an “Action” for each of those “Event Areas”. When the visual “Event” is triggered by the system reacting to a configurable change in view, the “Action” can toggle a “Patron Hand Visible” flag between 1 and 0 (1=Visible, 0=not Visible) and update the status in a database. Therefore, if the end of a “Dealer Hand” is reached as determined by the dealer hand state changing to “0”, any remaining “Visible” patron hands and occupied “Betting Areas” would suggest the patron “Won the Hand” since the cards were not removed before the Dealers cards were removed.

Patron Win/Loss statistics is critical to the Patron Rating process that is used for marketing compensatory rewards, for forecasting of Table Games personnel resources as well as minimum bet requirements on the Gaming Table, Pit Area, or Total Gaming Area as a whole.

By collecting the Patron Win/Loss statistics automatically, the Table Games Management System will maximize Table Play while reducing the human error factor. Internal or External Yield Management Software can query the data for: more accurately awarding marketing compensatory paybacks based on actual table play.

By tracking and comparing Patron Win/Loss statistics, a patron's “Skill Level” can be determined. By estimating “Patron Skill Level” automatically, the Table Games Management System will maximize Table Play while reducing the human error factor. Internal or External Yield Management Software can query the data for: more accurately awarding marketing compensatory paybacks based on Skill Level offset ratios.

In addition, the system controller 36 may monitor chip tray counts to maintain chip levels necessary for optimum table play. For example, the system may be configured to determine the “Chip Tray Count” in real-time including setting an “Event Area” in position T, and setting an “Action” for that “Event Area” to monitor changes in position “T”. The system controller 36 may configure the areas within the Event Area to represent the chip stacks, assign the “color range” for each denomination of chip values, and assign the “surface area” a single chip or a fixed group of chips would occupy. Based on the configured “area consumption” of each chip color in the “Event Area”, a chip count can be determine and automatically updated when the “Action Event” is triggered. Internal or External Table Management Software can query the data real-time to determine the Current Table Inventory. Internal or External Table Management Software can query the data real-time to suggest when a “Table Fill” or “Table Credit” is necessary. By automating solutions 1, 2 and 3 above, Table Play can be maximized by minimal interruptions.

In method step 312, the system controller 36 generates a current trend data set including the gaming metric records indicative of the gaming metric determined at corresponding time intervals within a predefined period of time, and generates and displays a current trend trace 104 (shown in FIG. 17) that is indicative of the current trend data set.

In method step 314, the system controller 36 determines a condition of the observation area 56 based on the current trend data. For example, the system controller 36 may determines a condition of the game play associated with the gaming table 64 as a function of the gaming metric and/or the current trend data. Moreover, the system controller 36 may determine the condition of the game play to be less than a predefined condition if the determined gaming metric is different than a predefined gaming metric.

In method step 316, the system controller 36 selects a corrective action as a function of the determined condition of the observation area 56 and displays a notification message indicative of the condition of the game play and the selected corrective action on the display device 32. In one embodiment, the system controller 36 may determine a historical trend data set similar to the current trend data set and select the corrective action as a function of the historical trend data set.

In method step 318, the system controller 36 generates a predictive trend data set as a function of the selected corrective action, and generates and displays a predictive trend trace 116 indicative of the predictive trend data set.

In one embodiment, the system controller 36 is configured to generate and display a Yield Management form 196 (shown in FIG. 16) that provides an overview of all of the gaming tables 64 within a casino and gives a system user visibility on how all of the gaming tables 64 are performing. The system user can visually see how busy the tables are and make decisions. In addition, the Yield Management form 196 allows the user to select corrective actions to enable the system controller 36 to gather data about the state of the casino during those times in order to see what kind of effect the decision had on the floor. The system controller 36 also generates and displays recommendations for corrective actions 198. There are two reasons a recommendation may be generated: 1. Based on seeing trends in devices and/or gaming tables over time matching configured recommendation parameters. One example is to recommend opening another table if a table has been full for 5 minutes. Another example would be to recommend raising the minimum wager on a table if it has exceeded ideal occupancy percentage by 15% for over 30 minutes. 2. Based on seeing a data trend that matches a previous action. For example, at 7 pm on a Friday night, the pit boss decided to raise the wager on a 5 Deck Blackjack table at $25 minimum bet. At this moment, the system controller 36 stores a trend prior to that action. If this trend is discovered again, it is recommended to repeat the action. If a recommendation is generated, a row will be added to the Recommendations table.

In the illustrated embodiment, the system controller 36 determines the total occupancy of the casino gaming environment based on the table occupancy rates of each open gaming table 64. The Casino box 200 shows a graphic displaying the occupancy of the floor overall. Each table has a configured ideal head count—if all tables match that ideal, it is at 100%. Otherwise, the system controller 36 calculates how far a table is from its ideal and subtracts the average of that value across all tables. For example, in one embodiment, BJ01 may be 0% occupied with an ideal of 25% and BJ02 may be 28.57% with a 29% ideal. BJ01 is 25% away from its ideal. 25% difference divided by 25% ideal results in a weight difference of 100% of the way away from its ideal. BJ02 is 0.43% from ideal. 0.43% difference divided by 29% ideal results in a weighted difference of 1.48% of the way away from its ideal. Between these two open tables, this is a total difference of 101.48% away overall, of an average of 50.74% off of overall ideal. The system controller 36 subtracts this number from 100% to result in 49.26%.

The Tables box 202 contains a tree of all tables on the casino floor, sorted by Pit (default) or Game. The device nodes show asset num, game, current min/max wager and current occupancy. Green light indicates a device is within 10% of ideal. Yellow lights indicate a device is over ideal by at least 10%. Red lights indicate a device is below ideal by at least 10%. Any parent node will have a red light if any child has a red light; a yellow light if any child has a yellow light and no child has a red light; a green light if all children have green lights. A selecting any icon displays a menu with the option to Perform Action on the device. Selecting “Perform Action” will pop up the Recommendation/Action window for this device. Recommendations/corrective actions may include open table, close table, raise minimum wager, and/or lower minimum wager. Recommendations for a table are represented by a recommendations icon 204.

In one embodiment, the system controller 36 may display the Yield Management form 196 including a Table Performance panel 206 (shown in FIGS. 16 and 17) that displays current gaming metric trend 104. In one embodiment, the Table Performance panel 206 may display the last 15 minutes of hands and their occupancy, along with the currently configured occupancy ideal for the table. In addition, the Table Performance panel 206 may show all child devices on the graph when selecting a zone/bank/game. For example, when a user access a gaming table 64 by selecting a device, the system controller 36 may open up the right side and load information about how well it is performing. Selecting a game/bank will load data about all devices contained.

The Recommendations box 208 displays all tables that have system generated recommendations. Upon selecting a row, the table will be selected in the Tables panel 206. Selecting the row brings up detailed analysis of the action. If occupancy has been higher than ideal for an extended period of time, it would make sense to open more tables or raise minimum bet. For example, if there were several $100 Blackjack tables showing a +10% occupancy for an extended period of time, it would make sense to open more. This will hopefully help the floor manager have a bird's eye view of data of the floor and can assist in making decisions to maximize profit.

The recommendations will be generated based on a thread reading the current data and comparing it to configured records in database 50. If there is enough data matching a trend, a record will be created and displayed in this window.

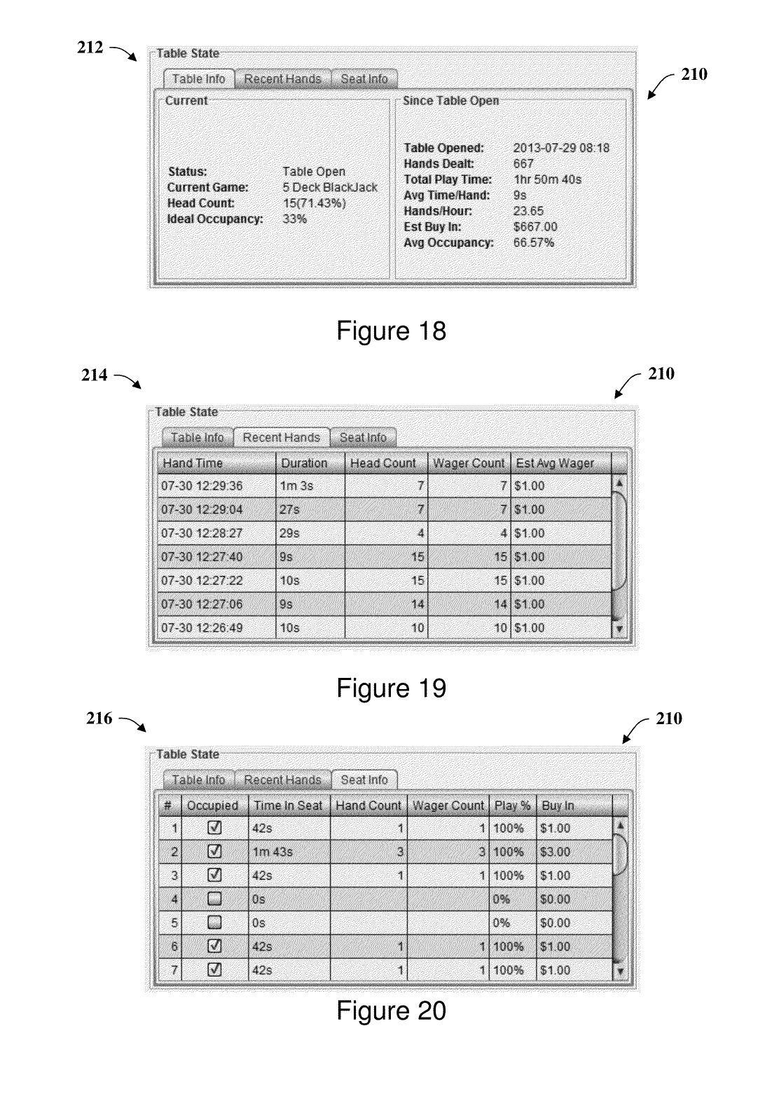

The system controller 36 may also generate and display a Table State form 210 (shown in FIGS. 18-20) including information associated with a gaming table 64. For example, in on embodiment, the system controller 36 may generate and display the Table State form 210 including three categories of data including Table Information tab 212, Recent Hands tab 214, and Seat information tab 216.

Table Information tab 212 displays data current state of table(s) and data about the corresponding gaming table 64 since opening. Current box: Status: Table's status; Current Game: If the table is open, this displays the current game; Head Count: Number of occupied seats, along with the percent of full occupancy; Ideal Occupancy: Configured ideal occupancy for this game/min max wager. Since Table Open panel includes data since the last table opener: Table Opened: date/time when this table opened; Hands Dealt: number of hands since the table opened; Total Play Time: Total time elapsed while a game is actively played. Time spent shuffling or between hands is not counted; Avg Time/Hand: Total Play Time divided by Hands Dealt; Hands/Hour: Hands Dealt divided by Number of Hours Since Opener; Est Buy In: Estimated Buy In, which is added by taking the minimum wager times wager count each hand over all hands dealt since opener. If there is an open table rating, the average wager of that seat is used instead of minimum wager. Avg Occupancy: Average of head count divided by total number of seats across all hands since opener.

Recent Hands tab 214 displays data about the recently completed hands on the corresponding gaming table 64. Hand Time: Date/Time hand started; Duration: Amount of elapsed from the hand starting to the hand ending; Head Count: Number of occupied seats for the hand; Wager Count: Number of occupied bets for the hand; and Est Avg Wager: Average wager per person. If no ratings open, all patrons are set with minimum bet of the table. Otherwise, open ratings can sway this number.

Seat information tab 216 displays data about the individual seats on the corresponding gaming table 64. No. #: Seat Number; Occupied: Checked if the seat is occupied; Time In Seat: amount of time elapsed since this seat was first occupied; Hand Count: number of hands that have been dealt since the seat was occupied; Wager Count: number of hands where this seat has bet since the seat was occupied; Play %: Wager Count divided by Hand Count; and Buy In: Amount this seat is estimated to have wagered since the seat was occupied. If there is an open rating for this seat, the buy in will increment by that rating's average wager for each hand the seat has bet on. Otherwise, it will increment by the table's minimum wager for each hand this seat has bet on.

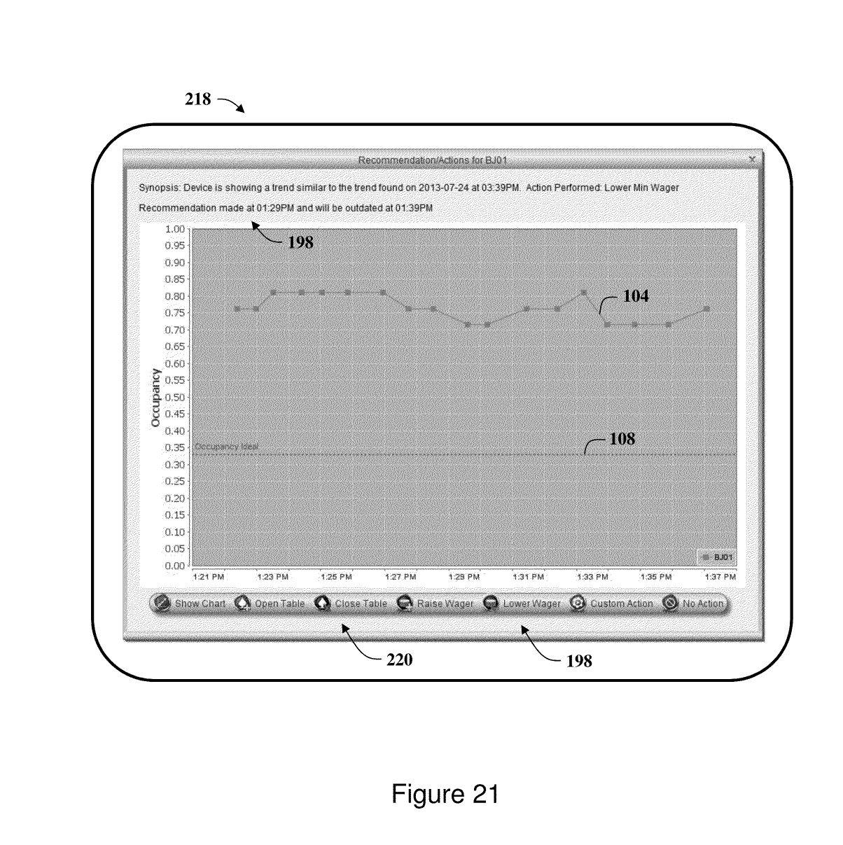

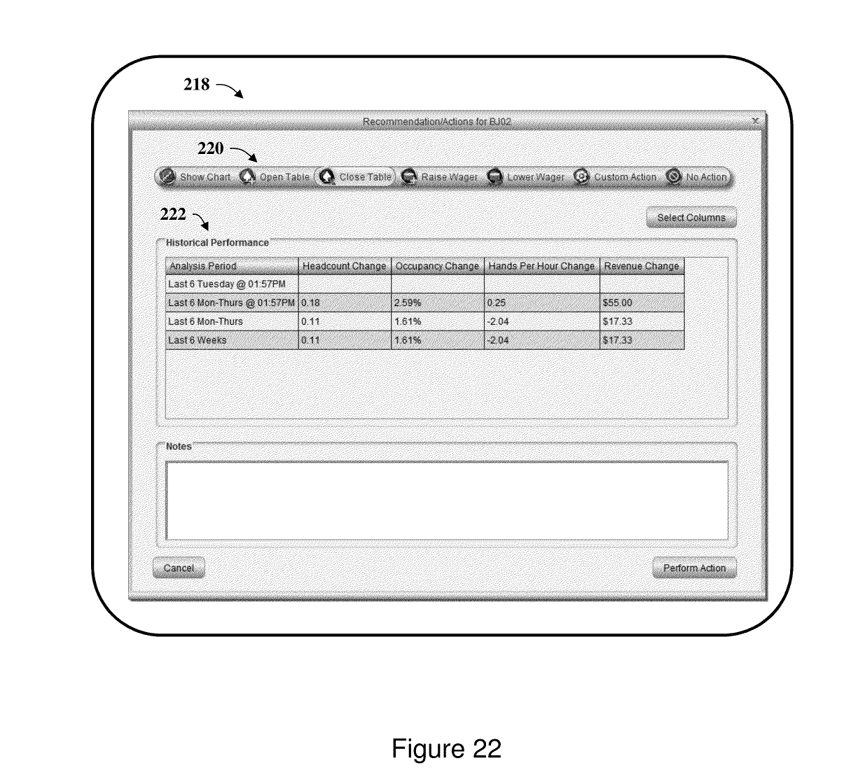

In one embodiment, the system controller 36 may display a Recommendations/Corrective Actions form 218 (shown in FIGS. 21-22) including information related to current trend data and corrective actions. The Recommendations/Actions form 218 allows the user to decide to perform an action on a device/gaming table 64. If a record in the Recommendations box 208 is selected or if a device with a recommendation is selected, the Recommendations/Actions form 218 is displayed with a header describing the reason for the recommendation. The recommendations will either match a basic recommendation to open/close table or raise/lower minimum wager or it will reference a historical trend found when a previous action was implemented. The form 218 may display the last 15 minutes of hands, table occupancies and the current configured occupancy ideal for this game/min max wager.

The bottom portion displays a tab/action selector control 220. Selecting an action will slide the selector to the top of the screen and display a Historical Performance Chart 222 (shown in FIG. 22) that displays historical statistics for the selected action. For example, when a user selects an action, the system controller 36 displays a corresponding Historical Performance Chart 222. The system controller 36 gathers data about the hands played at the corresponding gaming table 64 surrounding the last times this action was performed. Analysis may be gathered at 4 time periods: 1) Last 6 [Day of Week] @ [Current Time]: All actions on this device in the last 6 weeks on the same day of the week and within an hour of current time are gathered. All hands played within a 15 minute period of those actions are pulled and analyzed. 2) Last 6 [Weekday/Weekend] @ [Current Time]: All actions on this device in the last 6 weeks during the week or weekend (depending on current day of week) within an hour of current time. All hands played within a 15 minute period of those actions are pulled and analyzed. 3) Last 6 [Weekday/Weekend]: All actions on this device in the last 6 weeks during the week or weekend (depending on current day of week), over the course of the whole day. All hands played within a 15 minute period of those actions are pulled and analyzed. 4) Last 6 Weeks: All actions on this device in the last 6 weeks. All hands played within an hour of those actions are pulled and analyzed.

A user may also select various gaming metrics that may be generated and displayed by the system controller 36 by selecting “Select Columns”. The gaming metrics that are analyzed and displayed may include:

Head Count: Head Count Before: For each action, analyze only hands occurring BEFORE action date/time. Add up the headcount of each hand, and divide by number of hands and that yields an average headcount prior to action for that action. Across each action, average this value. Head Count After: Same as above, but using only hands AFTER action date/time. Head Count Avg: Same as above, but using hands before and after the action date/time. Head Count Change: Head Count After minus Head Count Before.

Occupancy: Occupancy Before: For each action, analyze only hands occurring BEFORE action date/time. Calculate occupancy for each hand (head count divided by total number of seats on table) and find the average occupancy across all hands. This is the Occupancy Before for that action. Repeat for each action and average across all actions to get an overall Occupancy Before value. Occupancy After: Same as above, but using only hands AFTER action date/time. Occupancy Avg: Same as above, but using hands before and after the action date/time. Occupancy Change: Occupancy After minus Occupancy Before

Hands Per Hour: Hands Per Hour Before: For each action, analyze only hands occurring BEFORE action date/time. Count number of hands dealt prior to action and calculate a hands per hour rate (hands dealt divided by minutes times 60). Average this hands per hour rate across all actions. Hands Per Hour After: Same as above, but using only hands AFTER action date/time. Hands Per Hour Avg: Same as above, but using hands before and after the action date/time. Hands Per Hour Change: Hands Per Hour After minus Hands Per Hour Before.

Revenue: Revenue Before: For each action, analyze only hands occurring BEFORE action date/time. Calculate revenue for this action—Head Count Before times table minimum bet. Average this revenue across all actions. Revenue After: Same as above, but using only hands AFTER action date/time. Revenue Avg: Same as above, but using hands before and after the action date/time. Revenue Change: Revenue After minus Revenue Before.

Cost: Cost Before: For each action, analyze only hands occurring BEFORE action date/time. Calculate the cost per hand by dividing Cost per hour (configured on Yield Management Setup form) for all staff on this game/minmaxwager by number of hands played. Average this cost across all actions. Cost After: Same as above, but using only hands AFTER action date/time. Cost Avg: Same as above, but using hands before and after the action date/time. Cost Change: Cost After minus Cost Before.

Profit: Profit Before: Revenue Before minus Cost Before. Profit After: Revenue After minus Cost After. Profit Avg: Sum of all Revenue minus sum of all Costs. Total divided by number of hands. Profit Change: Profit Before minus Profit After.

The system controller 36 may also display 6 recommended options: Raise Min Bet, Lower Min Bet, Open Table, Close Table, Custom, No Action. The Recommended option will be marked with an animated yellow circle, while the most often used option (if it is not the recommended option) will be marked with a blue circle. Selecting any action to see historical data about that action. The actions also serve as a selection when deciding what action to perform.

The system controller 36 may also provide the user the option of selecting a previously used Custom Action or creating a new one. For a new action, there is no historical data, and it will not be displayed. Like the pre-existing actions, these selected custom actions will also generate historical data as they are used. The user will be informed that their action has been noted and will be used in future recommendations.

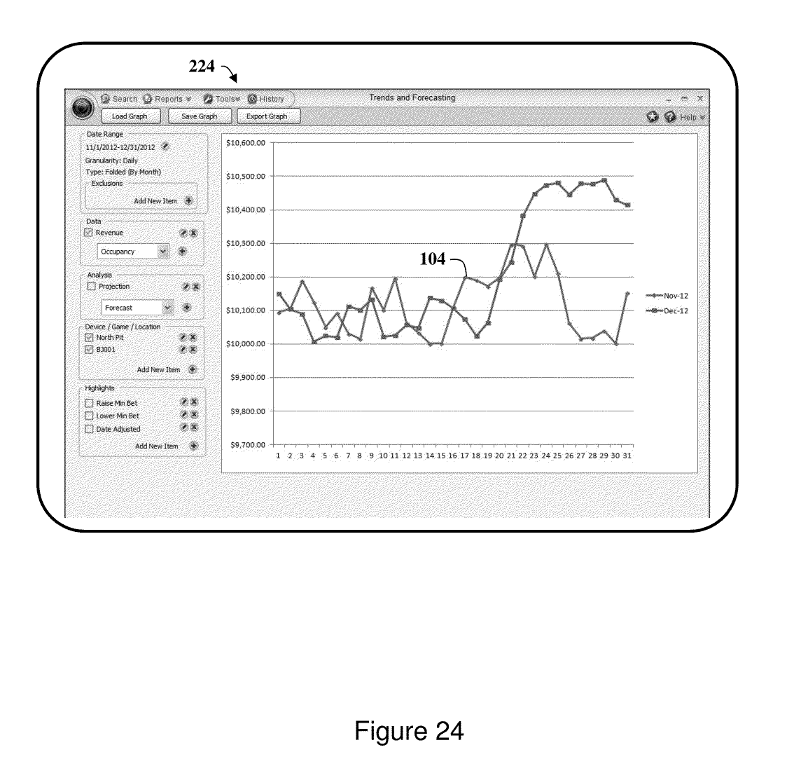

In one embodiment, the system controller 36 may also generate and display a Trends and Forecasting form 224 (shown in FIGS. 23 and 24) that includes information indicative of current trend data, historical trend data, and predictive trend data associated with one or more gaming tables 64. The Trends and Forecasting form 224 contains graphs to display data including previous data and predictive future data. The system controller 36 also allows a user to select the date range to analyze, the granularity it uses, and the type of graph it is. User can change the range/granularity or graph type.

Standard graphs show the x-axis spanning from the dates specified in the Start End Date. When a graph is set to Folded, the x-axis spans the length of the selected granularity (date/time period) and there will be a line on the graphs for each item at the selected granularity. This provides the user a chance to see data from two different time periods on top of each other.

For example, as shown in FIG. 24, a graph mapping Revenue over the period from November 2012 to December 2012 may be folded by month at a daily granularity, the graph should show two lines—one for November 2012 Revenue and one for December 2012 Revenue. Notice the x-axis spanning days 1-31, rather than the full date range specified—this is because we have “folded” the calendar months on top of each other, providing a single space to compare two comparable chunks of time. The system controller 36 also allows the user to exclude specific dates from the graph and select individual dates, months or days of the week to be included or excluded from the graph.

The system controller 36 also allows the user modify the values that will be measured in the graph. For example, the user may add additional gaming metric values including Revenue, Occupancy, Profit, Hands Per Hour, and Avg Bet. In addition, the user may select any number zone/bank/device or game/min bet combination. The user may select specific Zone/Bank/Device or Game/Min Bet. If Device is selected, the user can navigate a tree to find the objects they want to include as a filter for the grid. If Game/Min Bet is selected, user can select a game/min bet combination to add to the filters.

The system controller 36 may also allow users to display predictive trend data associated with a gaming table 64. For example users may display Projection, Forecast, and Ideal trends as new lines in the graph for each item selected.

The predictive trend data is generated by analyzing current trend data over a period of time. in one embodiment, projections are determined by taking 6 historical data points to create projection values. Forecast values utilize the same formula as projections, but use current data as a seed point.

Projection Model: Projections generated by the system controller 36 may be based on measuring a value over a 6 week period. Projections can be configured to be influenced by predictable important dates (Holidays, pay day, sporting events). There are a variety of ways to analyze data to create projections. One option is Simple Moving Average (SMA) which plots the average of several data points in a row to create a moving average line over time. From here, The system controller 36 may also calculate the standard deviation to analyze the volatility of the value and use it to better prepare for upward/downward swings. Additional analysis may be performed including Cumulative Moving Average (CMA), Weighted Moving Average, and Exponential Moving average. Another algorithm that may be used is a triple exponential smoothing algorithm. In order to create forecasts, the existing actual data goes through a smoothing algorithm which gives greater weight to more recent data. This is a statistical algorithm provided by a NIST Handbook (National Institute of Standards and Technology, a part of the US Department of Commerce) designed to teach statistical methods to scientists and engineers.

The triple exponential smoothing takes a series of data from time 1-10 and creates smoothed data points from time 2-10. There are 3 additional parameters used to adjust the smoothed curve—one to adjust for historical demand, one to adjust for recent trend and another to adjust for seasonality changes. Depending on the values of the factors, the smoothed curve can have a wide amount of error from the original data points. The code can loop through all of the potential parameter values from 0 to 1 in order to find the curve with the least amount of error. This will ultimately provide a smooth curve indicative of the historical demand of the value, forecast based on weighted trends, and adjust for season changes.

Forecasting Model: A separate model for handling day-level forecasting is utilized by the system controller 36. Given live data, the forecasting model creates day-level forecasts by adjusting live data with the trends described in the Projection Model. While 6 weeks of data may provide a relative prediction of the swings of headcount we expect to see in the upcoming day, when the day actually comes and the casino strongly over performs or underperforms, the forecasting model would provide different values from the historical projection.

In one embodiment, the system controller 36 allows a user to input various costs associated with operating a gaming table 64 and selected corrective actions 198 based on the associated operating costs. For example, the user may input costs indicative of employee hourly wages. The system controller 36 may use these costs to determine how many units of cost are required to open a table or pit. This data is what is used when calculating cost per hour or cost per hand in the Yield Management Recommendation/Action and Historical analysis. The costs may be configured at a Cost Type, Game, Min/Max Wager level. This means that all devices matching that game and min/max wager values will have the configured cost type at that multiplier.

The system controller 36 may also allow the user to configure the ideal performance metrics of a Game with a specified Min/Max bet configuration. The user may identify all ideal performance values for each of the given metrics such as Occupancy, Average Bet, and Hands Per Hour.

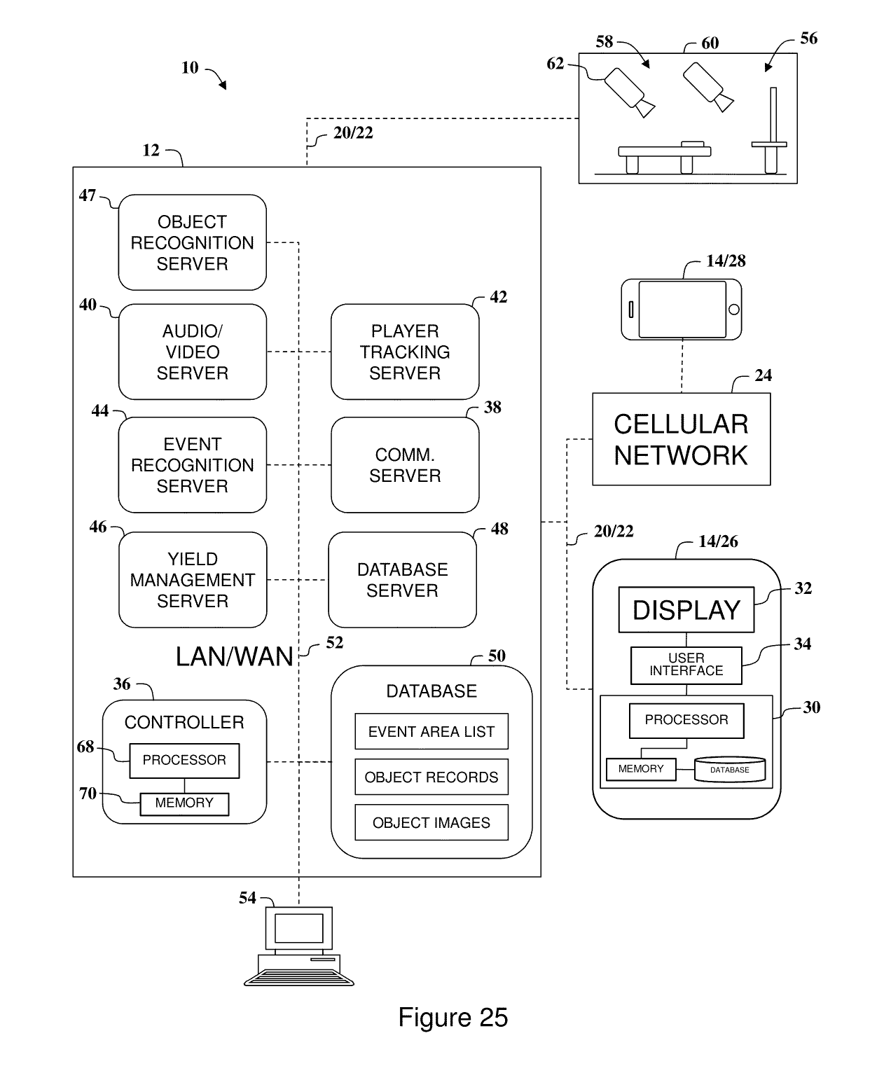

FIG. 25 is another schematic representation of the system 10 shown in FIG. 1, according to an embodiment of the invention. In the illustrated embodiment, the server system 12 includes the system controller 36, the communications server 38, the audio/video server 40, the player tracking server 42, the event recognition server 44, the yield management server 46, the database server 48, the database 50, and an object recognition server 47. In one embodiment, the database 50 may be configured to receive and store image data including area images, object images, enhanced area images, background images, detection images, normalized images, baseline images, image drawing objects such as lines and/or polygons, image characteristics such as color values, brightness values, contrast values, object attributes such as, for example, playing card dimensions, card rank, card suit, currency dimensions, currency type, currency denomination, wagering chip dimensions, chip color, chip value, chip tray dimensions, chip locations, object classifications, facial features, facial images, and the like.

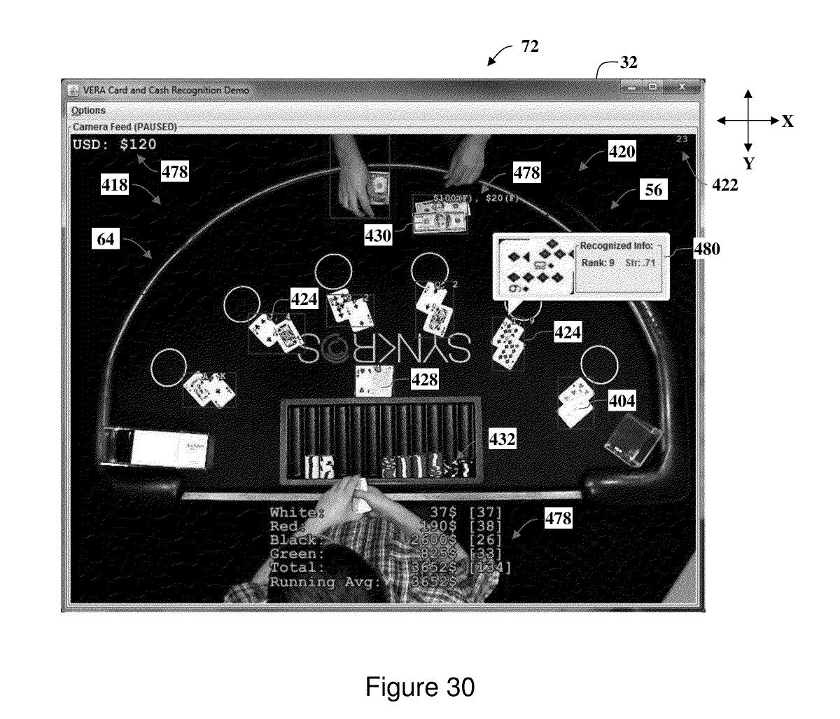

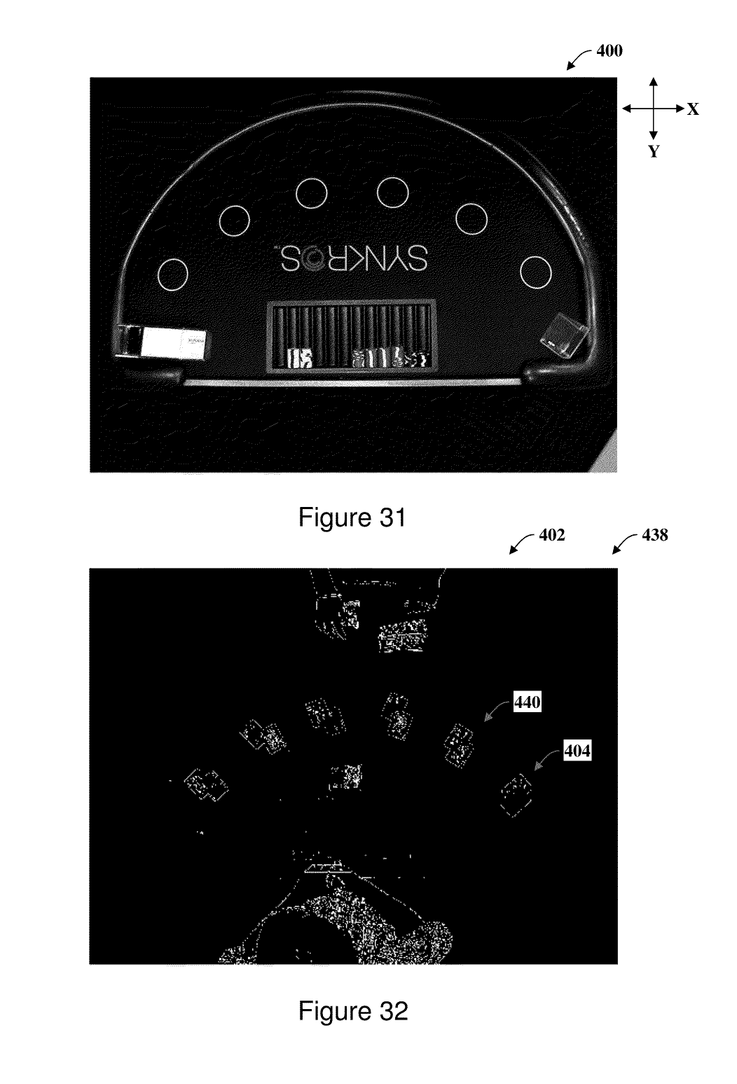

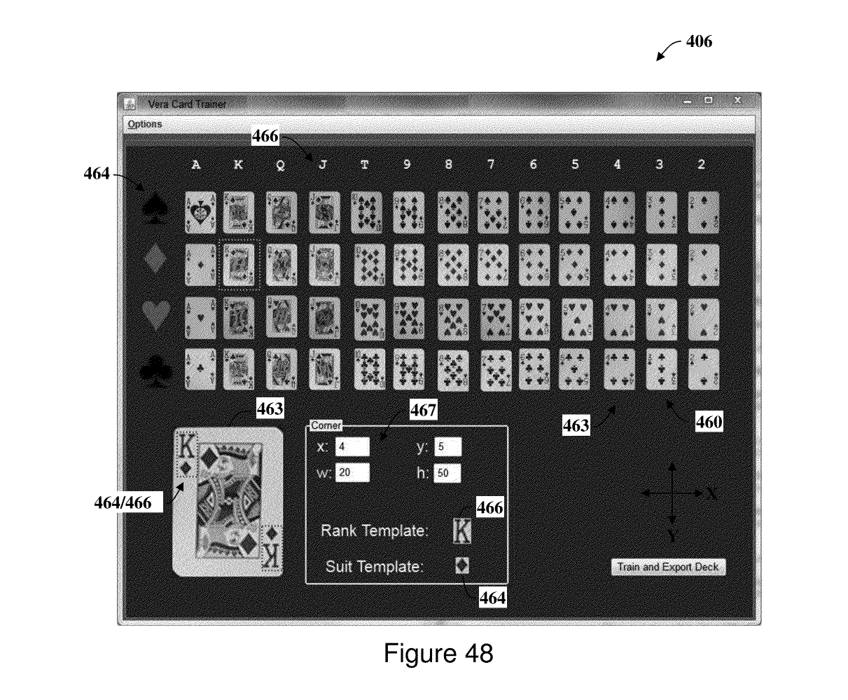

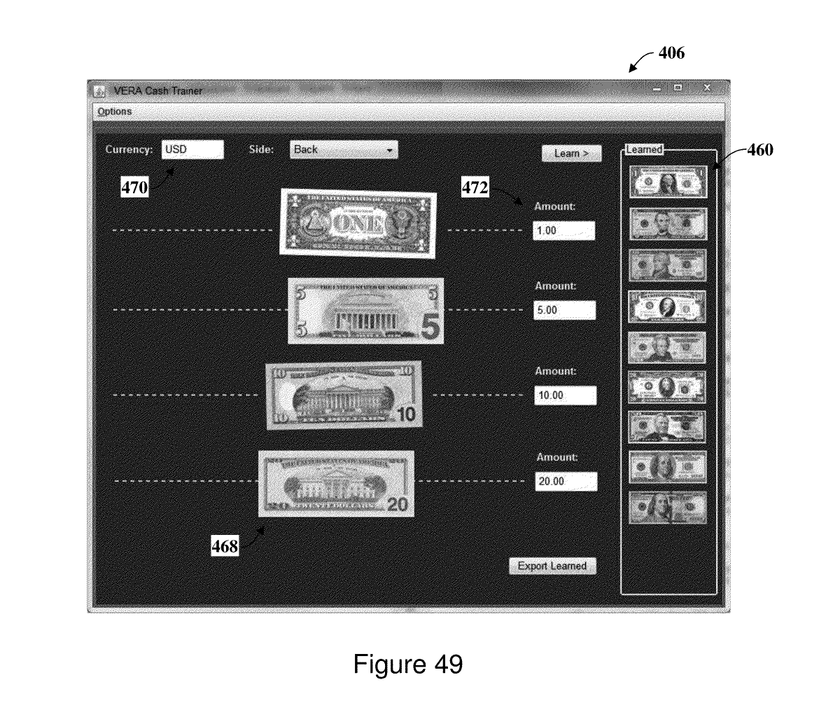

In the illustrated embodiment, the object recognition server 47 is configured to receive video image data from the audio/video server 40 a display the video image data in a display area 72 (shown in FIG. 30) on the display device 32. The object recognition server 47 compares the received video image with a baseline background image 400 (shown in FIG. 31), determines the corresponding images appearing in the received video image and the background image 400, and removes the corresponding images from the image file to generate a modified video image 402 (shown in FIGS. 32-43). The modified video image includes video objects 404 that are not included in the background image 400. The object recognition server 47 detects each remaining video object 404 being included in the modified video image 402 and compares each remaining video object 404 with one or more video object libraries 406 (shown in FIGS. 48 and 49) that include a plurality of known video objects to identify a matching known object contained in one of the libraries. In general, for each remaining video object 404, the object recognition server 47 determines a plurality of image attributes being associated with the video object and compares each attribute with corresponding attributes being associated with each known video object included in the video libraries to determine a number of matching attributes. The object recognition server 47 may also determine a number of matched attributes and identity the video object as a corresponding known video object based on the number of matched attributes.

In one embodiment, the object recognition server 47 may receive video images including a game being played at a gaming table and determine an identify of gaming objects being used with the game including, but not limited to, a suit and/or rank of playing cards, an amount of playing cards, an amount of gaming chips, a value of a gaming chip, monetary instruments, a denomination of monetary instruments, and/or any suitable gaming object that may be used with the game. In addition, in one embodiment, the object recognition server 47 may receive video images of an area adjacent to a gaming machine including images of a player playing a game at the gaming machine. The object recognition server 47 may detect an object within the video image including a figure such as, for example, a human face, and identify a plurality of attributes being associated with the figure. For example, in one embodiment, the object recognition server 47 may conduct facial recognition and determine attributes associated with the human face including, but not limited to, an age, a gender, a race, an expression, an identify of the player, and/or any suitable attribute that may be associated with the figure.

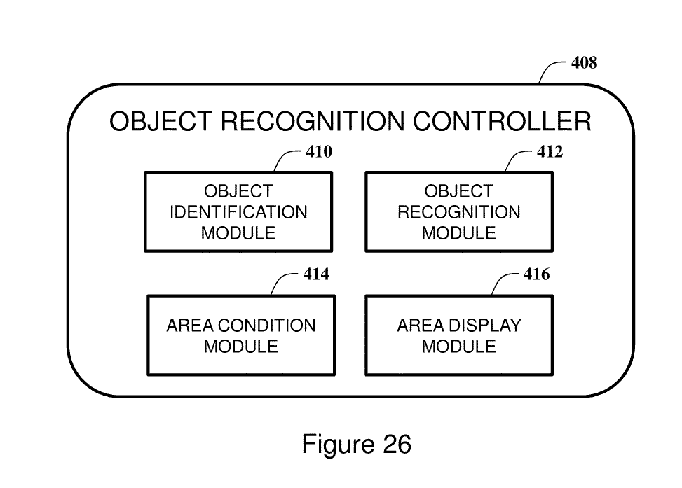

FIG. 26 is schematic view of an object recognition controller 408 that may be included in the object recognition server 47. In one embodiment, the object recognition controller 408 may be included in the system controller 36. In the illustrated embodiment, the object recognition controller 408 includes an object identification module 410, an object recognition module 412, an area condition module 414, and an area display module 416.

In general, the object recognition controller 408 is configured to receive an area image 418, recognize objects being displayed within the area image 418 including determining attributes associated with the recognized objects, and display an enhanced area image 420 including the recognized object attributes being displayed with the area image 418. In one embodiment, object recognition controller 408 may receive a live video feed of the observation area 56 and store a plurality of area images 418 in the database 50 including individual video frame images of the live video feed. The enhanced area image 420 may be displayed with corresponding video frame image information 422 such as, for example, time, date, and frame number. For example, in one embodiment, as shown in FIG. 30, the area image 418 may include a gaming table 64 and the displayed object attributes may include, but are not limited to, playing card ranks, a playing card suits, a currency denominations, a wagering chip values, and an amount of wagering chips.

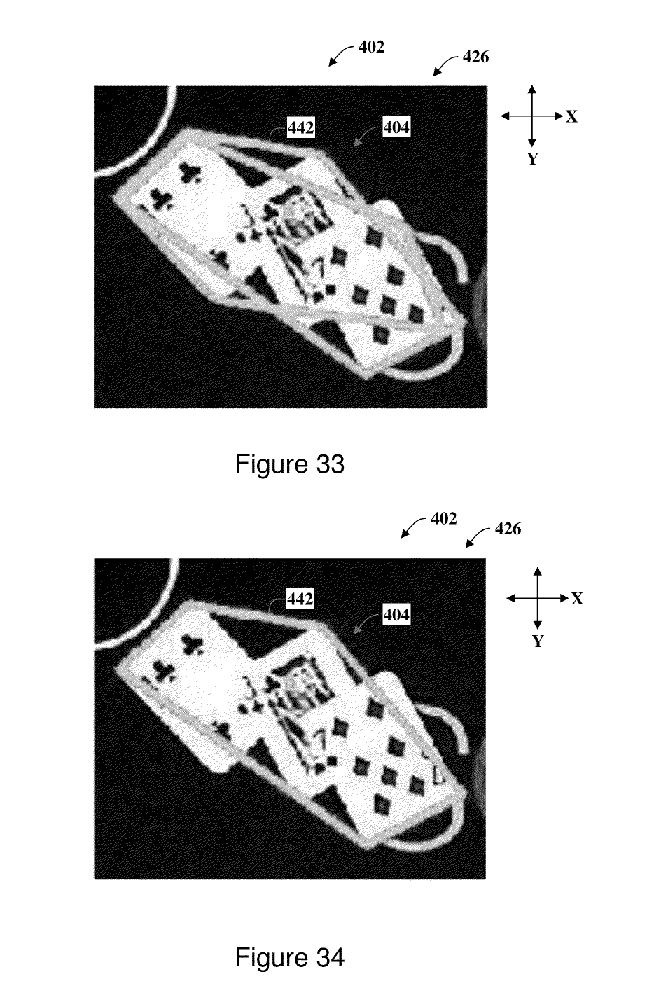

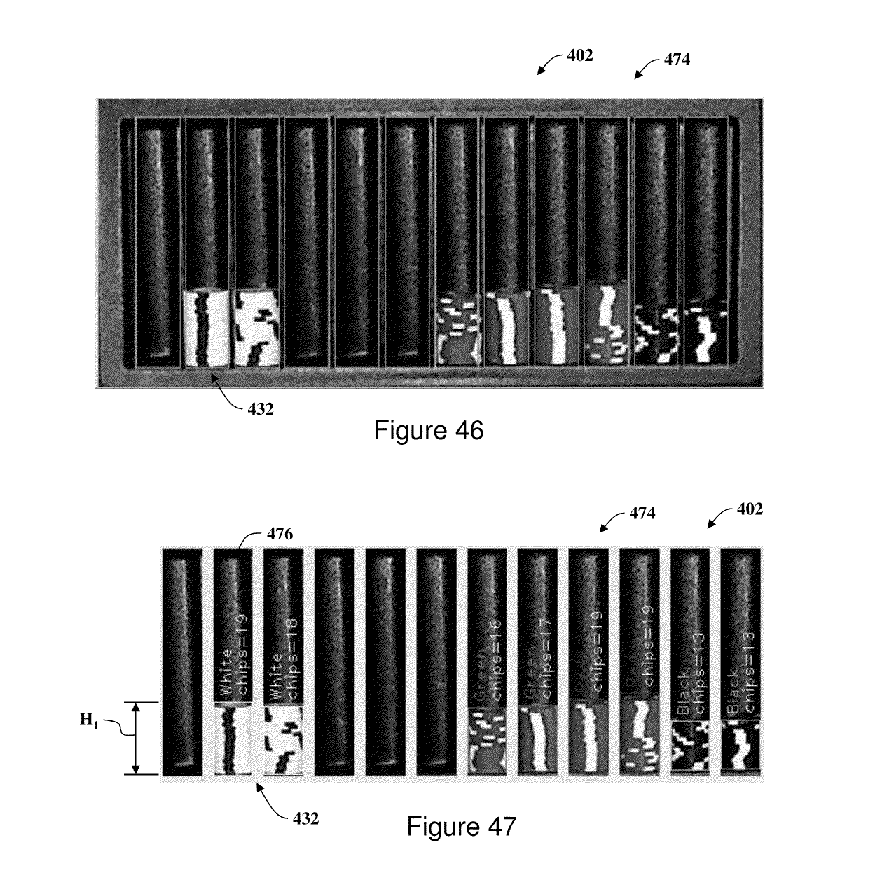

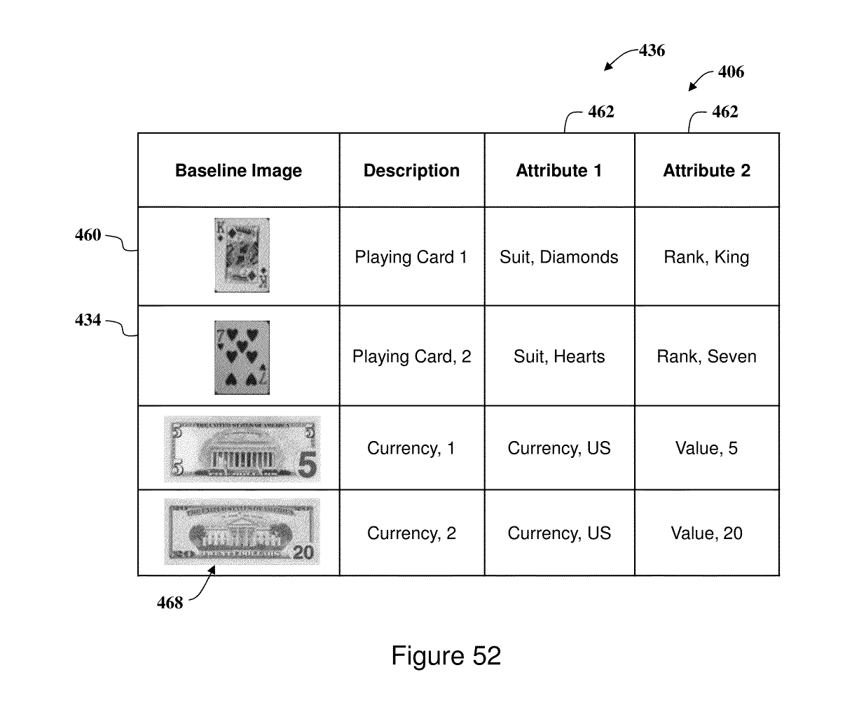

In the illustrated embodiment, the object identification module 410 is configured to receive the area image 418 (shown in FIG. 30) including an observation area 56 within a gaming environment from the image broadcast system 60 and store the area image 418 in the database 50. In one embodiment, the observation area 56 may include a gaming table 64. The object identification module 410 identifies one or more regions of interest 424 as a function of the received area image 418 and generates one or more object images 426 (shown in FIGS. 33-47) based on the identified regions of interest 424. The regions of interest 424 may include one or more objects 404 such as, for example, a playing card 428, currency 430, and/or wagering chip 432, being displayed within the corresponding region of interest 424. The object identification module 410 generates an object image 426 (shown in FIGS. 33-43) based on the image being displayed within a corresponding region of interest 424 and generates and stores an object record 434 (shown in FIG. 52) in an object record list 436 contained in the database 50 for use in recognizing the object 404 being displayed within the object image 426. The object record 434 may include image data indicative of the object image 426.

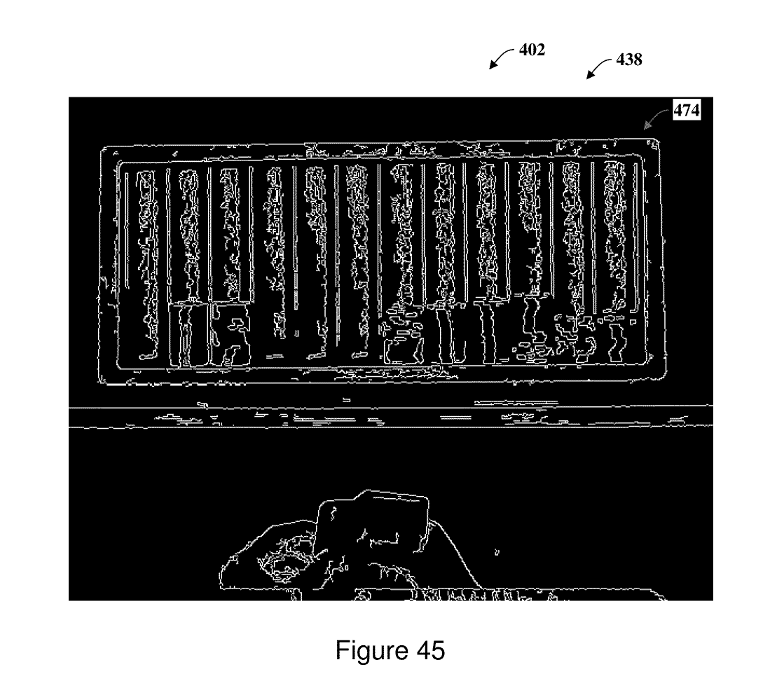

In one embodiment, the object identification module 410 is configured to generate a detection image 438 (shown in FIGS. 32 and 45) for use in identifying the regions of interest 424. For example, the object identification module 410 may select a background image 400 (shown in FIG. 31) from the database 50 as a function of the received area image 418 and generate the detection image 438 including selecting the background image 400 and subtracting the background image 400 from the area image 418. The object identification module 410 may also identify area contours 440 (shown in FIG. 32) that are indicative of objects 404 being displayed within the detection image 438 and generate a plurality of polygons 442 associated with the objects as a function of the area contours 440. Moreover, the object identification module 410 may select a polygon 442 associated with an identified region of interest 424 and generate a corresponding object image 426 as a function of the selected polygon 442.

In one embodiment, the image data associated with the area image 418 may include coordinate data associated with an image coordinate system. For example, in one embodiment, a Cartesian coordinate system may be used including two perpendicular axes X and Y that are used to define a two-dimensional Cartesian coordinate system relative to the area image 418. The X-axis may be orientated along a horizontal axis and the Y-axis may be orientated along a vertical axis. The object identification module 410 may determine a coordinate location of each of the polygons in relation to the area images 418 and map the polygons 442 to the area image 418 based on the image coordinates. The object identification module 410 then removes the background image 400 from the area image 418 to generate the object image 426 including a portion of the area image 418 being displayed within an area defined by the selected polygon 442.

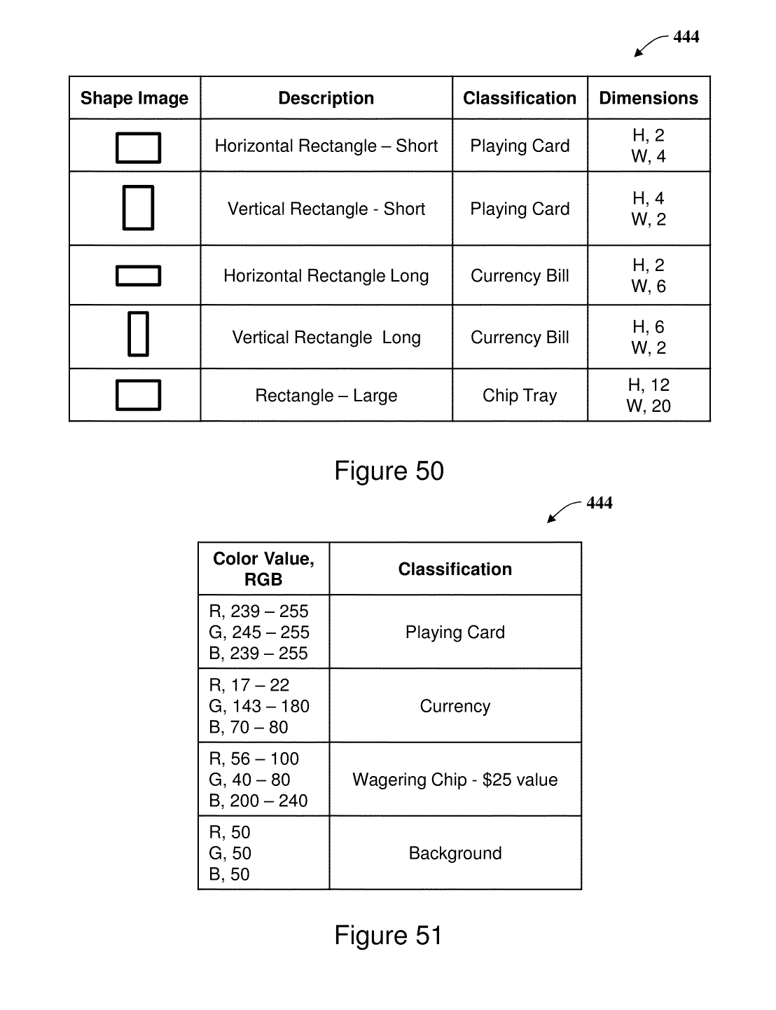

The object identification module 410 may also classify the object image 426 into one of a plurality of predefined object classifications based on the observation area 56, and generate the corresponding object record including the determined classification. For example, if the observation area 56 includes a gaming table 64, the object identification module 410 may classify the object as being one of a playing card, currency, and/or wagering chip. Moreover, the object identification module 410 may classify the object image 426 as a function of an image characteristic such as, for example, an image color value, brightness, and/or contrast. For example, the database 50 may include a classification list 444 (shown in FIGS. 50 and 51) including a plurality of classifications and corresponding image characterizes. The classifications may include, but are not limited to, playing cards, wagering chips, chip tray, currency, and the like. In one embodiment, the object identification module 410 may determine a color value associated with the object image 426 and select a classification from the classification list as a function of the color value and associate the classification with the object image. For example, in one embodiment, the object identification module 410 may classify the object image 426 as a playing card based on the color value included with the object image 426.

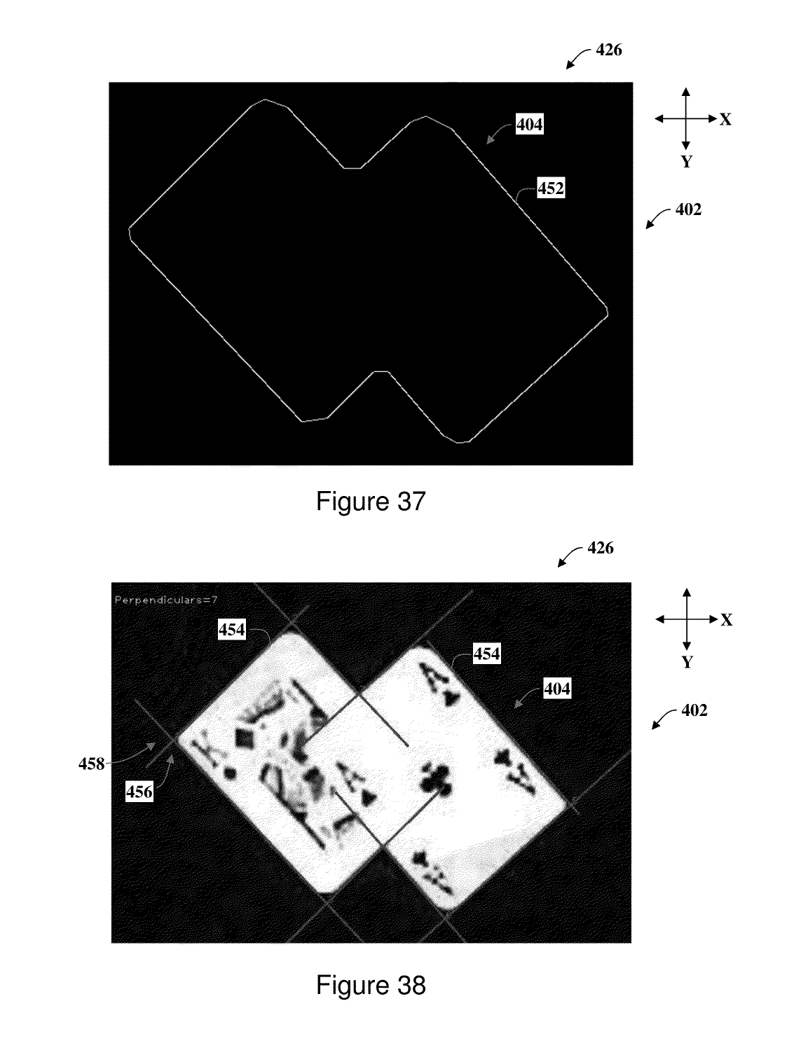

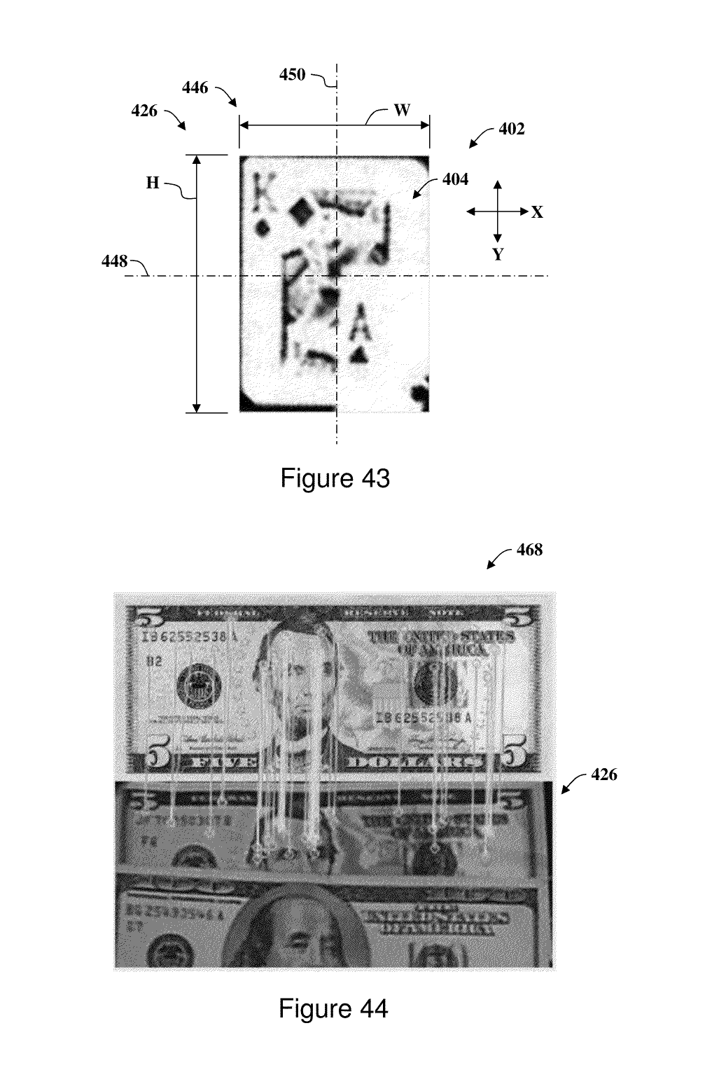

The object identification module 410 may also generate a normalized object image 446 (shown in FIG. 43) as a function of the object image 426 for use in recognizing the object 404 being displayed within the normalized object image 446. In the illustrated embodiment, the normalized object image 446 is generated with a predefined height, H, and a predefined width, W, to facilitate recognizing the object being displayed within the normalized object image 446. The object identification module 410 may also orient the object image 426 along a horizontal axis 448 and a vertical axis 450 to generate the normalized object image 446. In one embodiment, the object identification module 410 may generate an outline 452 (shown in FIG. 37) of the object being displayed in the object image 426, generate a plurality of boundary lines 454 (shown in FIG. 38) as a function of the outline 452, and generate the normalized object image 446 as a function of the boundary lines 454.

In one embodiment, the object identification module 410 may identify a valid corner section 456 (shown in FIG. 38) of the object 404 as a function of the boundary lines 454. For example, the object identification module 410 may identify an intersection of boundary lines 454, identify four quadrants 458 (shown in FIG. 38) being formed at the intersection, and determine a color value for each quadrant 458. If the color value is different for one of the four quadrants, the object identification module 410 may determine the identified intersection as a valid corner section 456. For example, as shown in FIG. 38, a valid corner section 456 may include one of the quadrants having a color value that is indicative of a playing card and the remaining quadrants having color values indicative of the background image 400.

The object identification module 410 may also select an object outline shape from the database 50 as a function of the valid corner section 456, and generate the normalized object image 446 as a function of the selected object outline shape. For example, the object image 426 may be classified as a playing card. The object identification module 410 may rotate the object image to normalize the image along the X and Y axes, select one or more object outline shapes from the database 50 that are indicative of playing cards, match the object image with one of the object outline shapes, and generate the normalized object image 446 based on the matching outline shape. For example, in one embodiment, the object identification module 410 may overlay a first vertically oriented rectangular shape over the object image 426 and determine an amount of background image being displayed within the vertically oriented shape. If background image is detected, the object identification module 410 may overlay a second horizontally oriented rectangular playing card shape over the object image 426 and detect the presence of the background image within the outline shape.

In the illustrated embodiment, the object recognition module 412 is configured to receive the object image 426 and/or the normalized object image 446 from the object identification module 410, recognize the object 404 being displayed within the received image, and associated object attributes to the object for use with the enhanced area image 420 (shown in FIG. 30). For example, in one embodiment the object recognition module 412 may recognize the object being displayed in the object image 426, associated attributes such as, playing card suit, card rank, and/or currency value, to the object, and generate and store the object record including the associated attributes for use in displaying the attributes to a user via the enhanced area image 420.

In one embodiment, the object recognition module 412 determines a baseline object image file 460 (shown in FIG. 52) matching the object being displayed in the object image 426, identifies the attribute associated with the matched baseline object image file 460 and generates the corresponding object record including associating the corresponding object attributes included in the matching baseline object image file to the object. Each baseline image 460 may also include a corresponding object attribute 462 including, but not limited to, a playing card rank, a playing card suite, a currency denomination, a wagering chip value, and an amount of wagering chips. For example, in one embodiment, the database 50 may include a library a baseline playing card images 463. Each baseline playing card image 463 may include a suit image 464, a rank image 466, and a coordinate location 467 of the suit and rank images relative to the playing card image 463. In addition, the database 50 may also include a library of currency images 468 including information associated with currency type 470 and denomination 472.

In the illustrated embodiment, the object recognition module 412 compares the object image 426 and/or the normalized object image 446 with one or more baseline object images 460 and generates a confidence value that is indicative of an amount of matched image features between the compared images. The object recognition module 412 may also select a matching baseline image 460 based on the generated confident values. For example, in one embodiment, the object recognition module 412 may select a matching baseline image file having a corresponding confidence value that is greater than, or equal to, a predefined confidence value.

In one embodiment, the object recognition module 412 may include a template matching program that is configured to initiate a template matching operation to match baseline images 460 to the object image 426 and/or the normalized object image 446. For example, in one embodiment, the template matching program may include a template matching program provided by OpenCV™ such as, for example, “cv2.matchTemplate( )”. In general, the template matching program selects a template image from the database, overlays the template image over the input image, and compares the template image and the portion of the input image under the template image. The program than moves the template image to another adjacent location and compares the template image with the adjacent portion of the input image portion. This process may continue on a pixel by pixel basis until the template image has been compared with each portion of the input image. For example, referring to FIGS. 43 and 48, in one embodiment, the object recognition module 412 may select a baseline playing card image 463 from the database 50, select the corresponding suit image 464 and initiate the template matching operation including overlaying the suit image 464 over each portion of the normalized object image 446. In addition, the object recognition module 412 may overlay the suit image 464 over a predefined portion of the normalized object image 446 based on the coordinates associated with the corresponding suit image 464.

The object recognition module 412 may also include a feature detection program that is configured to detect image features being displayed with the object image 426 and/or the normalized object image 446, determine matching image features being displayed on the baseline image 460 and the object image 426 and/or the normalized object image 446, and generate the confidence value based on the number of similar features. For example, in one embodiment, the feature detection program may feature detection program provided by OpenCV™ such as, for example, “FeatureDetector” and/or the “FAST” algorithm. There are several Template Matching programs and Feature Detection programs that may be used with the object recognition module 412, accordingly, the invention is not limited to the template matching and/or the feature detection programs described herein.

In one embodiment, the object recognition module 412 may select the matching program as a function of the classification of the corresponding object image 426. For example, the object recognition module 412 may select the template matching operation or the feature detection operation as a function of the classification of the object image 426. In one embodiment, the object recognition module 412 may select the template matching operation if the classification is a playing card and select the feature detection operation if the classification is a monetary currency.

In the illustrated embodiment, the area condition module 414 retrieves the object records from the database 50 and generates an area metric associated with the observation area 56 as a function of the object attributes contained in the object records. For example, in one embodiment, the observation area 56 may include a gaming table 64. The area condition module 414 may retrieve the object records associated with the observation area, determine an area metric including a table state associated with the gaming table as a function of the object attribute, and generate and store a table state record indicative of the determined table state in the database 50. Information associated with a table state may include, but is not limited to, identified player card hands, table currency values, chip values, chip tray values, player identification, win/loss table percentage, average game speed, dealer speed, dealer accuracy, patron win/loss ratio, and/or any suitable table metric. In one embodiment, the area condition module 414 may be programmed to perform each of the operations being performed by the yield management server 46. For example, the area condition module 414 may be programmed to determine an area characteristic and/or gaming metric associated with the observation area 56 as a function of the object records, determine a condition of the observation area 56 as a function of the determined area characteristics and/or gaming metric, and display a notification indicative of the determined condition with the enhanced area image 420. Area characteristics and/or area states may include, but is not limited to, gaming metrics associated with game play, person occupancy levels, condition changes associated with the observed environment, and/or any suitable characteristic that may be associated with a changes and/or modifications of an observed environment.

The area display module 416 is configured to retrieve the object records and the table states and/or area characteristics from the database 50, and generate and display the enhanced area image 420 including the area image 418 overlaid with the object attributes and/or table states/area characteristics on the display device 32.

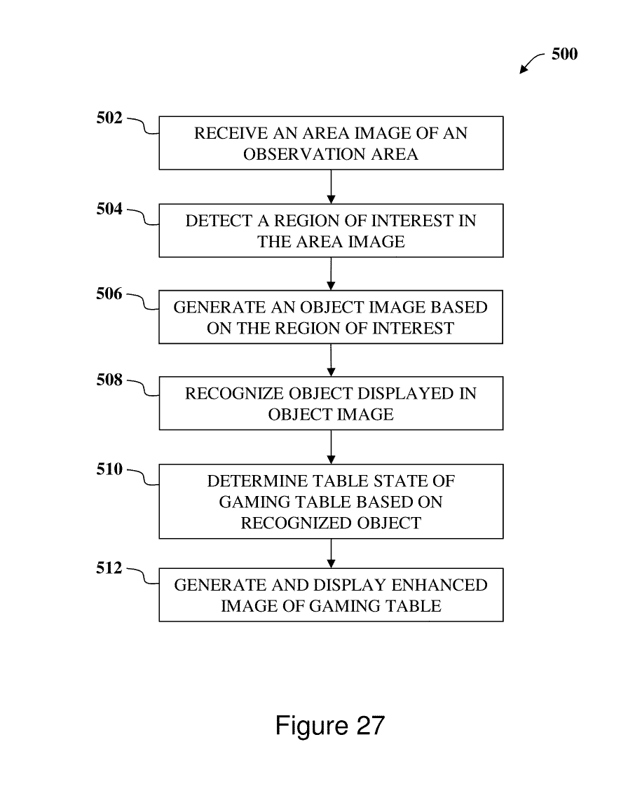

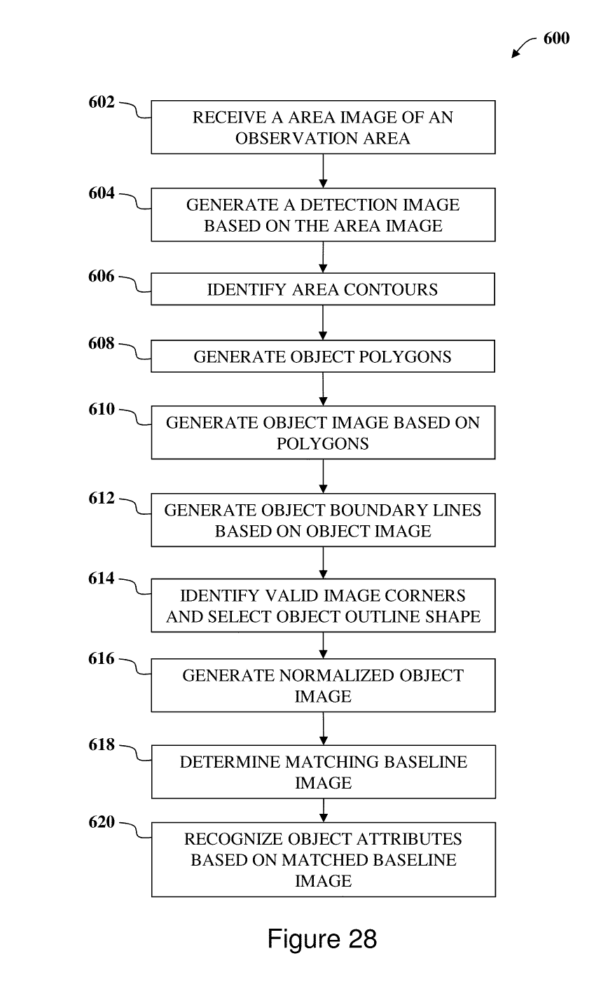

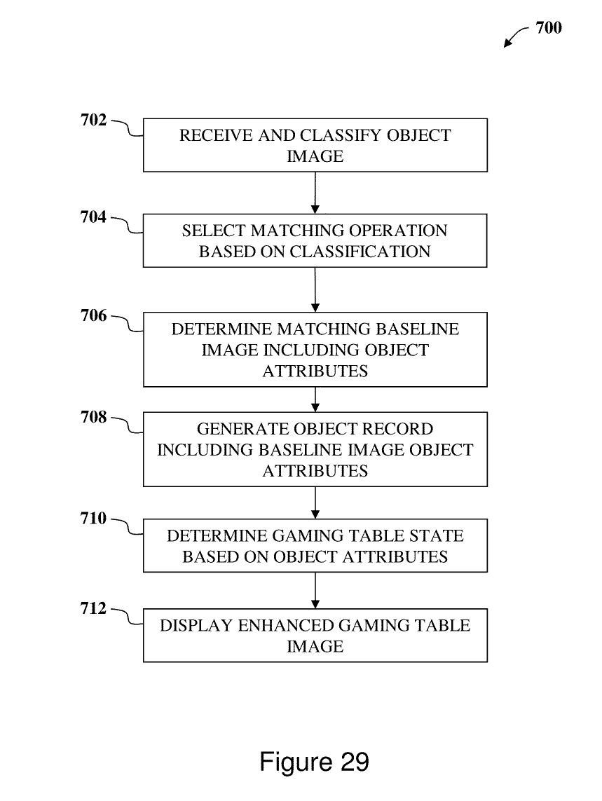

FIGS. 27-29 are flowcharts of methods 500, 600, and 700 that may be used with the system 10 for operating a gaming environment. The methods 500, 600, and 700 include a plurality of steps. Each method step may be performed independently of, or in combination with, other method steps. Portions of the methods may be performed by any one of, or any combination of, the components of the system 10. FIGS. 30-52 are exemplary graphical displays of operating screens that may be displayed by the system 10.

In the illustrated embodiment, in method step 502, the controller 408 receives an area image 418 including an observation area 56 within the gaming environment from the audio/video capture device 62. The controller 408 stores the area image 418 in the database 50. In one embodiment, the observation area 56 may include a gaming table 64. In method step 504, the controller 408 detects a region of interest 424 that is being displayed in the area image 418. In method step 506, the controller 408 generates an object record 434 that includes an object image 426 associated with the region of interest 424. The object image 426 includes an object 404 being displayed within the region of interest 424. For example, in one embodiment, the controller 408 may detect a playing card being displayed in the region of interest 424.

In method step 508, the controller 408 recognizes and identifies the object being displayed within the object image 426 and assigns an object attribute to the object image 426. For example, in one embodiment, the controller 408 may identity a baseline object image 426 that matches the object image 426, identify the attributes 462 associated with the matched baseline object image 426, associate with the identified attributes 462 with the object image 426, and generate and store an object record 434 including the object image 426 and the associated attributes 462.

In method step, 510 the controller 408 determines a table state associated with the gaming table 64 as a function of the recognized object image 426 and the corresponding object attributes 462, and generates and stores a table state record indicative of the table state in the database 50. In method step 512, the controller 408 generates and displays an enhanced area image 420 including the area image 418 of the observation area 56 and the determined table state on the display device 32.

In one embodiment, the controller 408 may be programmed to implement method 600. In method step 602, the controller 408 is programmed to receive an area image 418 including an observation area 56 from the audio/video capture device 62. The observation area 56 may include a gaming table 64. In method step 604, the controller 408 generates a detection image 438 based on the area image 418. For example, in one embodiment, the controller 408 generates the detection image 438 including selecting a background image 400 of the gaming table 64 from the database 50 and subtracting the background image 400 from the area image 418. For example, a noisy background, e.g. a background image having a high contrast value and/or high color variations, may make object detection and recognition difficult. Removing most of the background without removing the objects improves success rate. The controller 408 accomplishes this by capturing a clean image of the gaming table with no cards, cash, hands, chips, etc. whenever possible, and then subtracting this image from each live image frame. A problem may occur when the background image has areas that are similar to an object's foreground. For example, white betting circles and letters may be the same color as a playing card's white area. The controller 408 may perform object foreground masking to correct objects that have parts subtracted.

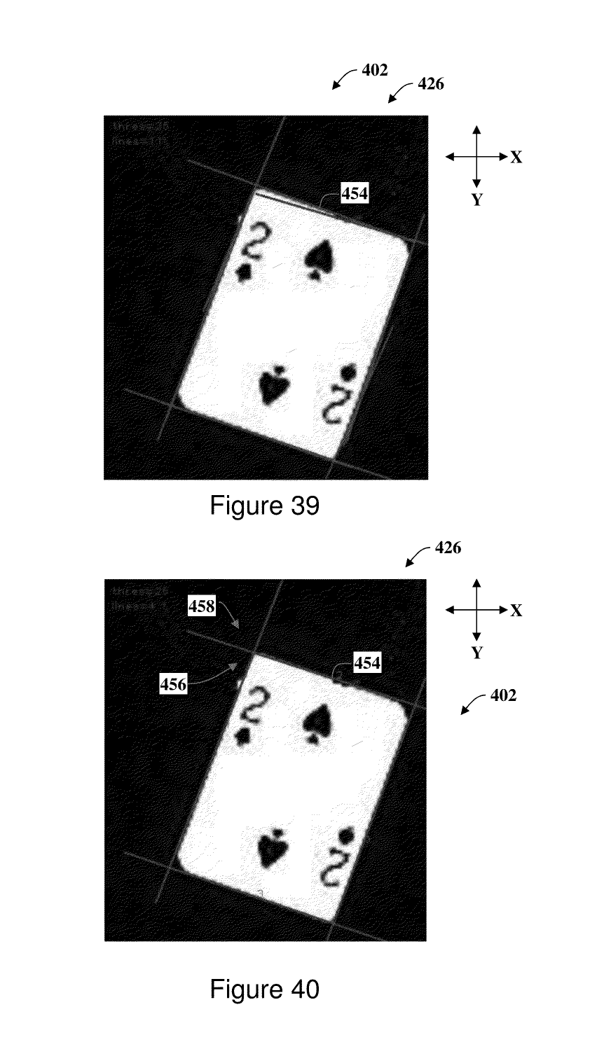

In method step 606, the controller 408 identifies area contours indicative of objects being displayed within the detection image 438. For example, the controller 408 determines if regions of interest 424 exist in the detection image 438. The controller 408 applies edge detection filters to the detection image 438. The result after background subtraction and edge detection filtering is an outline of the image as shown in FIG. 37. The controller 408 then identifies contours in the detection image 438. In method step 608, the controller 408 generates a plurality of polygons 442 associated with the objects as a function of the area contours. The contours can be converted to polygons and assigned areas. Objects can be filtered, sorted, and classified according to these areas. Duplicate overlapping polygons can be eliminated or merged as shown in FIGS. 39 and 40.

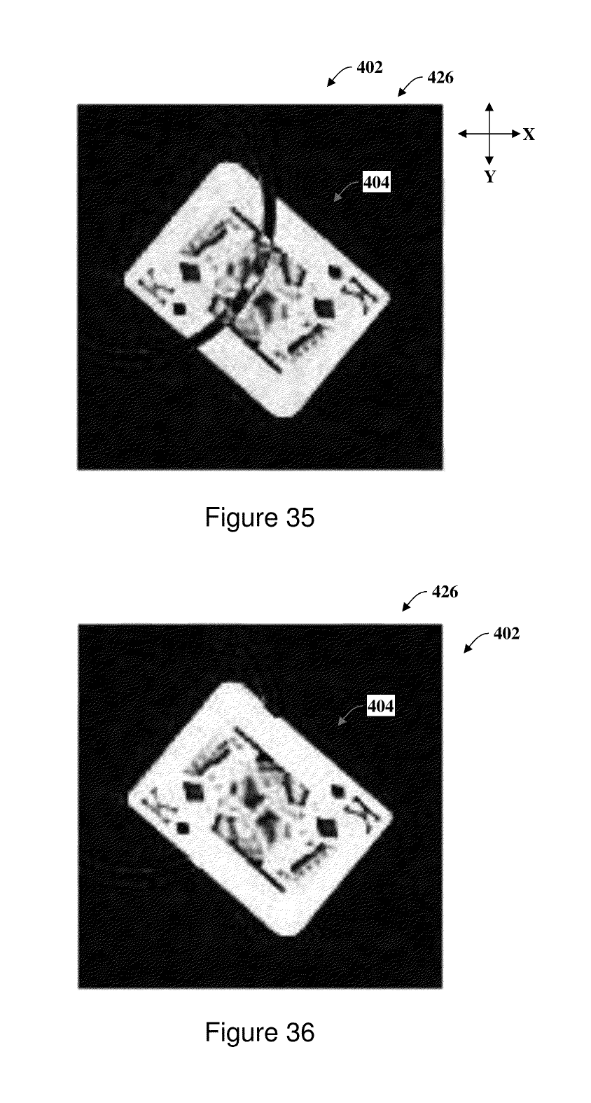

In method step 610, the controller 408 selects a polygon 442 associated with a region of interest 424 and generates an object image 426 as a function of the selected polygon. For example, in one embodiment, the controller 408 maps the polygons to the area image 418, removes the background image 400 from the area image 418, and generates the object image 426 including a portion of the area image 418 being displayed within an area defined by the selected polygon. For example, after eliminating or merging duplicate polygons, the controller 408 classifies these objects by mapping the coordinates of the polygons back to the original area image 418 and measuring color values. The controller 408 can use the information gained to reliably find regions of interest 424 and classify them as cards, cash, or anything other suitable classification. The controller 408 creates an image from a padded bounding box around the polygon to use in further stages of object recognition. The controller 408 may also minimize the part of the object that may have been subtracted by pasting the foreground over the polygon while keeping the area outside the polygon in a subtracted state as shown in FIGS. 35 and 36.

In method step 612, the controller 408 generates object boundary lines 454 based on the object image 426. For example, in one embodiment, the controller 408 generates an outline of the object being displayed in the object image, and generates a plurality of boundary lines 454 as a function of the outline. The controller 408 prepares these objects for recognition and produces an image of each sub-object found with a normalized size and orientation. The controller 408 may first find an outline of the object. This outline will be used to find lines and corners of the object. The accuracy of the outline is very important so the controller 408 applies several image filters to improve the outline. The controller 408 may scale, dilate, erode, or perform other image enhancement operations. For example, FIG. 38 illustrates the results for a detected object of two overlapping cards. Using the outline, the controller 408 may generate lines and groups of lines. Lines close to other lines with similar slope may be grouped together, merged, and extended as shown in FIGS. 39 and 40. For example, FIG. 39 shows eleven lines. Grouping and merging the lines resulted in four lines shown in FIG. 40, and a more accurate bounding of the object.

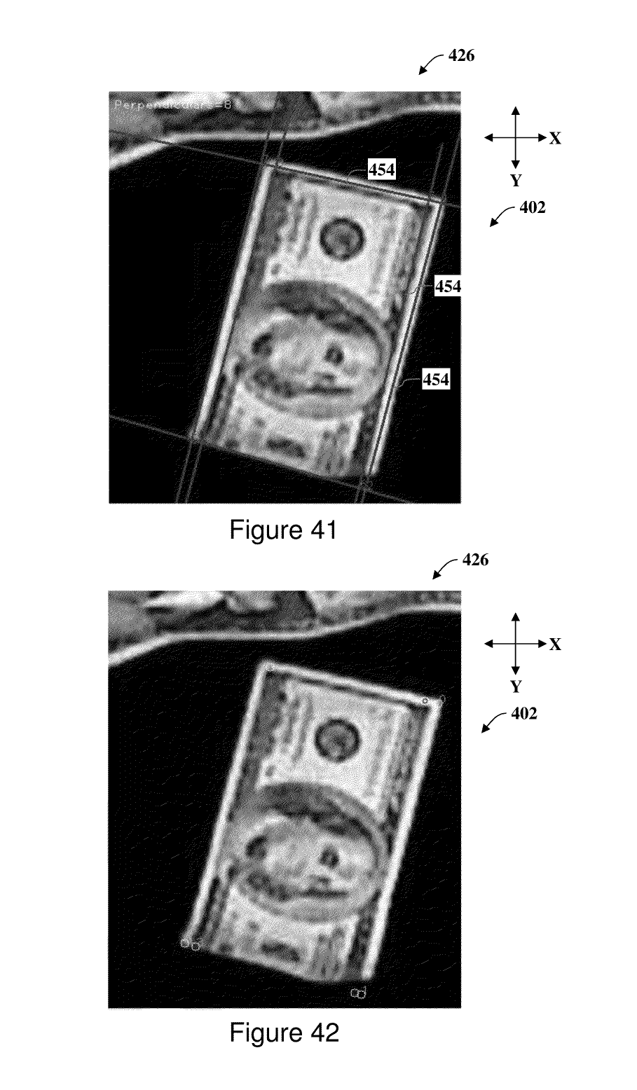

In method step 614, the controller 408 identifies valid image corners and selects an object outline shape based on the valid image corners. For example, the controller 408 may identify a valid corner section of the object as a function of the boundary lines and select an object outline shape from the database as a function of the valid corner section. In one embodiment, after grouping and merging lines, the controller 408 determines the intersections of the remaining lines. The controller 408 reviews each of these intersections to see if the intersections are close to perpendicular and can be considered a corner of an object, as shown in FIG. 38. For each perpendicular line, the controller 408 may measure the color of each corner section. If the controller 408 finds perpendicular lines with one corner having the color value of a playing card and the three other corners having the color value of the background, then the controller 408 determines that a valid corner has been found to use for cutting out a card image. The controller 408 may also use the same process to identify cash currency. For example, in one embodiment, shown in FIGS. 41 and 42, despite the controller's 408 efforts to merge lines and find perpendiculars, the controller 408 may still generate some questionable results such as, for example, lines that are just far enough apart or have slopes just different enough that prevent the lines from being merged. In these cases, the controller 408 identifies and eliminates inferior perpendiculars so the controller 408 does not waste time cutting out and recognizing duplicate images from similar perpendiculars. In one embodiment, the quality of each perpendicular is measured by the difference in color. Perpendiculars that are near each other are compared by quality, and the lesser ones are removed. FIGS. 41 and 42 illustrate this operation with small circles with dots identifying lower quality perpendiculars that are removed.

In method step 616, the controller 408 generates a normalized object image 446 as a function of the outline shape. For example, for every good corner remaining, two potential cards are made (long and short). One of these cutouts will be incorrect and usually eliminated by measuring the amount of background in the cutout. The correct cutout provides the four corners of a potential object to perform a perspective corrected transform. The transform cuts out the card and puts it into an upright position with a normalized size that can be used for the recognition phase. The controller 408 may generate a matrix that is used to do the transform which may be stored in the database 50 for use in the recognition phase to map additional points from the actual image to the normalized one. FIG. 43 illustrates a normalized card image.

In method step 618, the controller 408 determines a baseline object image 426 matching the object being displayed in the object image 426. A baseline object image file is generated and stored in the database and includes corresponding object attributes 462. In method step 620, the controller 408 recognizes object attributes 462 based on the match baseline image 460 and generates a corresponding object record to associate the corresponding object attributes included in the matching baseline object image file to the object.

In one embodiment, the controller 408 may be programmed to implement method 700. In method step 702, the controller 408 receives the object image 426 and classifies the object image 426. For example, the controller 408 may determine a color value of the object image 426 and determine a classification of the object image as a function of the color value. In addition, the controller 408 may classify the object image 426 as a playing card, currency, or a wagering chip. In one embodiment, the controller 408 may identify a valid corner section of an object within the object image 426 as a function of the boundary lines 454, select an object outline shape from the database as a function of the valid corner section 456, and classify the object and/or object image 426 as a function of the selected object outline shape.

In method step 704, the controller 408 selects a matching operation based on the object classification. For example, the controller 408 may select a template matching operation and/or a feature detection operation as a function of the classification. In one embodiment, the controller 408 may select the template matching operation if the classification is a playing card and select the feature detection operation if the classification is a monetary currency.

In method step 706, the controller 408 conducts a recognition phase operation and performs the selected matching operation to select a matching baseline object image 426 including corresponding object attributes from the database 50. For example, in one embodiment, for playing cards, the controller 408 performs the template matching operation for each rank image 466 and each suit image 464. The controller 408 may make the assumption that cards will always have their rank in the top left and bottom right corners. This property along with the clarity of the rank lends itself well to a form of recognition known as template matching. Templates for each rank in the deck have been made and normalized with a Card Training application. The corners of the card being recognized are used as the ‘Scene’. The controller 408 looks for template matches in both of these corner scenes. If the controller 408 finds a strong match, the controller 408 may short circuit the process. Otherwise, the controller 408 may match every rank template stored in the database 50 against the corner scenes in the object image 426 and remember the strongest ones. The template matching operation also generates a confidence rating that may be used to filter out the weak matches. Suits are matched in a similar manner. In addition, the controller 408 may perform template matching while also using color value measurements to improve the accuracy. The size of the normalized scenes and templates affect the performance of template matching, so the controller 408 may make both as small as possible while still obtaining reliable results.

In one embodiment, the controller 408 may perform feature detection to recognize currency. Template matching may not work as well for cash and/or currency because the features on cash are not as distinct, there is more variation in the corners, and cash doesn't lay as flat on the table as cards. For example, the cash can be wrinkled and bent so the controller 408 may not be able to obtain accurate coordinates for corners as can be obtained for cards. However, cash typically has more details than playing cards so it works well with another method of object recognition: Feature Detection. The feature detection methods used by the controller 408 may depend on finding key points in the cash image. There are many different feature detection algorithms available. The controller 408 may use several different ones and choose the most effective one based on accuracy, speed, and cost. The controller 408 may train the feature detector program with templates of all currency that may be detected. The key points for the trained templates are loaded from the database so the controller 408 may compare the templates with live cash regions of interest. Matching a region of interest against the trained cash provides a confidence value for each template. The controller 408 retains the highest matches for each denomination above a certain threshold and accepts those bills as being in the region of interest. The controller 408 may cut those matches away from the region of interest and re-run the feature detector to see if additional matches can be found. This process continues until no matches above the configured confidence threshold are found. FIG. 44 is a graphical representation of feature detection on a bill.

After the first pass of recognition on cards and cash, the controller 408 reduces the number of objects to recognize on additional passes. For example, objects with confidence levels below thresholds are removed, objects having a high percentage of overlap but lower confidence than recognized objects in the same area are removed, and/or objects containing too much background are removed. The recognition phase for an object may be expensive and require significant computing resources, so the extra effort of minimizing the number of objects processed is important.

In one embodiment, the controller 408 may detect a wagering chip tray 474 in the area image 418. The controller 408 detects the bounds of the chip tray by looking for a large rectangular contour in a specific sub-section of the image. This sub-section may be defined in the application settings. Measuring the chip tray first requires a clear view of it. Depending on the angle of view, a table dealer may frequently be obstructing the view. The controller 408 attempts to make a clean outline of the tray, and if a clean outline cannot be made, it is assumed that the dealer or something else is in the way and skips chip tray detection for the current frame. FIG. 45 is an example of an outline image that may be used as a clean view of the chip tray. From this clean outline view the controller 408 can accurately find the corners and normalize the chip tray, similar to the normalization performed for cards and cash. The controller 408 identifies the positions of the tray columns 476 that hold the chip stacks. These column positions for a normalized view of the tray are specified in the application configuration. The controller 408 may use color and intensity measuring to identify the type of chip in each column. The controller 408 then estimates how many chips are in each column by its height Hi (see FIG. 47) and performing error correction on the top and bottom of each stack.

In method step 708, the controller 408 generates an object record 434 including the attributes associated with the matched baseline image 460 and stores the object record 434 in the database 50. In method step 710, the controller 408 determines a gaming table state 478 as a function of the object attributes. In method step 712, the controller 408 generates and displays the enhanced area image 420 including overlaying the gaming table state 478 onto the area image 418. The enhanced area image 420 allows the user to monitor and track cash, cards and the state of the chip tray on a table. Records of the table's state may be generated and stored. For example, a user may use a computer mouse to hover over a detected object will display a popup window 480 with more detailed information. As shown in FIG. 30, the user has the mouse above a region of a detected object that is the nine of diamonds. The image in the popup window 480 is the normalized view of the card used in the recognition phase. The confidence level is shown as 0.71. It is green to indicate a strong match. Cash, Cards, and Chip Tray may use different detection and recognition methods with different values for confidence. The resolution of the image frames, camera's distance, and lighting will also affect confidence values.

The controller 408 may display additional features of this enhanced area image 420 including, but not limited to, the total amount of cash detected on the table shown in the top left corner, the frame number of the corresponding monitoring session shown as yellow text in the top right corner, and/or estimates for chips in the chip tray are shown just below the tray, including the current total and an average of the last several frames.

In one embodiment, the controller 408 may also include a card trainer application program that may be used to generate baseline object images 460 and records. The purpose of the card trainer application is to teach the object recognition controller 408 how to recognize a new deck of cards. For example, a user may arrange the cards of a deck in a grid in the order as printed on the felt surface as shown in FIG. 48. The application receives a video image of the deck of cards and automatically detects the bounds of each card and will recognize the card's rank and suit by the card's position on the grid. The controller 408 computes a default position for the card's corners, and estimates the positions of each card's rank and suit. If needed the user may adjust the discovered corner, rank and suit position values for individual cards. When the user is satisfied with the deck training, the user can request the application to export the image data to a zip file, and then import this deck into any of the object recognition applications.

The controller 408 may also include a cash trainer application. The cash trainer teaches the object recognition controller 408 how to recognize new currencies. The user places bills over dotted lines on the felt as shown in FIG. 49. The controller 408 receives an image of the currency and automatically detects the bounds of bills on each dotted line. The user enters the currency name and other global currency properties at the top of the screen, and enters each bill's value to the right of each bill. When the ‘Learn’ button is pressed, the trainer application normalizes each bill found on a dotted line, computes its key points with the feature detector, and makes a thumbnail image for displaying in the list of learned images to the right. When the user is finished learning the front and back of all bills in a currency, the controller 408 exports the image data to a zip file. The database 50 contains the normalized bills and key point information which can be used by other applications to recognize the currency.

In another embodiment, the controller 408 may be programmed to perform facial recognition. For example, OpenCV™ includes a large popular Computer Vision library that supports facial recognition. In addition to recognizing faces in images, the controller 408 may also use OpenCV™ to implement the following advanced features: Gender Detection, Emotion Classification, Glasses Detection, and/or Age Classification. A database of facial images is required, each marked by the desired classification (male/female, age, happy/sad, etc). Using a prediction model named ‘Tisherfaces’, a gender accuracy rating of approximately 98.5% may be achieved. The input for this model is a series of facial images. After feeding the model some sets of images for male and female, it is able to compute the average differences between males and females. For example, the primary differences in gender unsurprisingly appear to be around the eyes, eyebrows, and mouth. Moreover, the OpenCV tools compute an average image of each classification, and then can compare a new image against the average images and make an informed guess on the best fit classification for the new image.

In one embodiment, the object recognition controller 408 may also be programmed to perform cash verification or validation, game protection, and/or patron detection. For example, the controller 408 may perform cash verification or validation functions including, but not limited to, cash validation at Cashier, Cage, Table, etc., Jackpot Payouts and various other Payouts, Check cashing or credit card advances at Cage, Sports Book ticket cash outs, and/or CWA (Cashless Wager Accounting) and/or other types of buy-ins. The controller 408 may also perform Game Protection functions including, but not limited to, Win Loss verification, Buy-in and Pay-out accuracy, Detection of cash, chip, and racks, Measure game speed, Measure dealer speed and accuracy, Deck protection, finding card counters, detecting dealer or player cheating, Automated skill measurement, win/loss ratio per patron, Alerts and Notification support for certain events, Popup security alert, save image to DB, and send notification email, and/or Dice roll verification for craps and other dice games. In addition, the controller 408 may also perform Patron Detection functions including, but not limited to, Facial Recognition and/or Player Card recognition including QR Codes recognition and/or Bar Codes recognition.

Exemplary embodiments of a system and method for operating a gaming environment are described above in detail. The system and method are not limited to the specific embodiments described herein, but rather, components of the system and/or steps of the method may be utilized independently and separately from other components and/or steps described herein. For example, the system may also be used in combination with other wagering systems and methods, and is not limited to practice with only the system as described herein. Rather, an exemplary embodiment can be implemented and utilized in connection with many other monitoring applications.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing gaming system. The system of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto, either through a mobile device, gaming platform, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A system for use in operating gaming tables within a gaming environment, the system comprising:
a database;
a user computing device including a display device; and
a controller configured to:
receive an area image of an observation area within the gaming environment from a video imaging device and store the area image in the database, the observation area including a gaming table;
detect at least one region of interest being displayed in the area image;
generate an object record including an object image associated with the at least one region of interest, the object image including an object being displayed within the at least one region of interest;
identify an object attribute associated with the object as a function of the object image;
determine a table state associated with the gaming table as a function of the object attribute and generate and store a table state record indicative of the table state; and
generate and display an enhanced image including the area image of the observation area and the determined table state on the display device.

2. A system in accordance with claim 1, the object attribute including at least one of a playing card rank, a playing card suite, a currency denomination, a wagering chip value, and an amount of wagering chips.

3. A system in accordance with claim 1, the controller configured to:
generate a detection image including selecting a background image of the gaming table from the database and subtracting the background image from the area image;
identify area contours indicative of objects being displayed within the detection image;
generate a plurality of polygons associated with the objects as a function of the area contours;
select a polygon associated with the at least one region of interest; and
generate the object image as a function of the selected polygon.

4. A system in accordance with claim 3, the controller configured to:
map the polygons to the area image;
remove the background image from the area image; and
generate the object image including a portion of the area image being displayed within an area defined by the selected polygon.

5. A system in accordance with claim 4, the controller configured to:
generate an outline of the object being displayed in the object image;
generate a plurality of boundary lines as a function of the outline;
generate a normalized object image as a function of the boundary lines; and
identify the object attribute associated with the object as a function of the normalized object image.

6. A system in accordance with claim 4, the controller configured to:
identify a valid corner section of the object as a function of the boundary lines;
select an object outline shape from the database as a function of the valid corner section; and
generate the normalized object image as a function of the selected object outline shape.

7. A system in accordance with claim 1, the controller configured to:
determine a baseline object image file matching the object being displayed in the object image, the baseline object image file being stored in the database and including corresponding object attributes; and
generate the corresponding object record to associate the corresponding object attributes included in the matching baseline object image file to the object.

8. A system in accordance with claim 6, the controller configured to:
compare the object image with a plurality of baseline object image files stored in the database;
generate a confidence value associated with each baseline object image file; and
select the matching baseline object image file based on the confidence values.

9. A system in accordance with claim 6, the controller configured to determine a matching baseline object image file using at least one of template matching operation and feature detection operation.

10. A system in accordance with claim 8, the controller configured to:
determine a color value of the object image;
determine a classification of the object image as a function of the color value; and
select the at least one of the template matching operation and the feature detection operation as a function of the classification.

11. A system in accordance with claim 7, the controller configured to:
select the template matching operation if the classification is a playing card; and
select the feature detection operation if the classification is a monetary currency.

12. A method for use in operating gaming tables within a gaming environment, including the steps of:
receiving an area image of an observation area within the gaming environment from a video imaging device and store the area image in a database, the observation area including a gaming table;
detecting, by a processor, at least one region of interest being displayed in the area image;
generating, by the processor, an object record including an object image associated with the at least one region of interest, the object image including an object being displayed within the at least one region of interest;
identifying an object attribute associated with the object as a function of the object image;
determining a table state associated with the gaming table as a function of the object attribute and generating and storing a table state record indicative of the table state; and
generating and displaying an enhanced image including the area image of the observation area and the determined table state on a display device.

13. A method in accordance with claim 12, the object attribute including at least one of a playing card rank, a playing card suite, a currency denomination, a wagering chip value, and an amount of wagering chips.

14. A method in accordance with claim 12, including the steps of:
generating a detection image including selecting a background image of the gaming table from the database and subtracting the background image from the area image;
identifying area contours indicative of objects being displayed within the detection image;
generating a plurality of polygons associated with the objects as a function of the area contours;
selecting a polygon associated with the at least one region of interest; and
generating the object image as a function of the selected polygon.

15. A method in accordance with claim 14, including the steps of:
mapping the polygons to the area image;
removing the background image from the area image; and
generating the object image including a portion of the area image being displayed within an area defined by the selected polygon.

16. A method in accordance with claim 15, including the steps of:
generating an outline of the object being displayed in the object image;
generating a plurality of boundary lines as a function of the outline;
identifying a valid corner section of the object as a function of the boundary lines;
selecting an object outline shape from the database as a function of the valid corner section;
generating a normalized object image as a function of the boundary lines; and
identifying the object attribute associated with the object as a function of the normalized object image.

17. A system in accordance with claim 1, the controller configured to:
comparing the object image with a plurality of baseline object image files stored in the database, each baseline object image file including corresponding object attributes;
generating a confidence value associated with each baseline object image file using at least one of template matching operation and feature detection operation; and
selecting the matching baseline object image file based on the confidence values.
determining a baseline object image file matching the object being displayed in the object image based on the confidence values; and
generating the corresponding object record to associate the corresponding object attributes included in the matching baseline object image file to the object.

18. A method in accordance with claim 17, including the steps of:
determining a color value of the object image;
determining a classification of the object image as a function of the color value; and
selecting the at least one of the template matching operation and the feature detection operation as a function of the classification.

19. A method in accordance with claim 18, including the steps of:
selecting the template matching operation if the classification is a playing card; and
selecting the feature detection operation if the classification is a monetary currency.

20. One or more non-transitory computer-readable storage media, having computer-executable instructions embodied thereon, wherein when executed by at least one processor, the computer-executable instructions cause the processor to:
receive an area image of an observation area within the gaming environment from a video imaging device and store the area image in a database, the observation area including a gaming table;
detect at least one region of interest being displayed in the area image;
generate an object record including an object image associated with the at least one region of interest, the object image including an object being displayed within the at least one region of interest;
identify an object attribute associated with the object as a function of the object image;
determine a table state associated with the gaming table as a function of the object attribute and generate and store a table state record indicative of the table state; and
generate and display an enhanced image including the area image of the observation area and the determined table state on a display device.
